(19) United States
(12) Patent Application Publication
(10) Pub. No.: US 2020/0204841 A1
(43) Pub. Date: Jun. 25, 2020

(54) STREAMING FRAMES OF SPATIAL ELEMENTS TO A CLIENT DEVICE

(71) Applicant: TILEDMEDIA B.V., Rotterdam3 (NL)

(72) Inventors: Ray Van Brandenburg, Rotterdam (NL); Frederik Harm Klok, Rotterdam (NL); Robert Hendrik Koenen, Rotterdam (NL); Arjen Timotheus Veenhuizen, Rotterdam (NL)

(73) Assignee: TILEDMEDIA B.V., Rotterdam (NL)

(21) Appl. No.: 16/643,052

(22) PCT Filed: Sep. 4, 2018
(86) PCT No.: PCT/EP2018/073737

§ 371 Date: Feb. 28, 2020

(30) Foreign Application Priority Data
Sep. 11, 2017 (EP) 17190314.9

(51) Int. Cl. H04N 21/2343; H04N 21/218; H04N 21/845; H04N 21/4728; H04N 21/6587; H04N 21/81

(52) U.S. Cl. CPC H04N 21/234363; H04N 21/21805; H04N 21/8456; H04N 21/816; H04N 21/4728; H04N 21/6587; H04N 21/8455

(57) ABSTRACT

A method of transmitting a request for video data comprises a client device transmitting a request for high-resolution spatial-element frames of a spatial element of a video to a distribution node for each spatial element of the video in a user's field of view for which a client device does not possess a current high-resolution spatial-element frame. The video comprises a plurality of spatial elements and the plurality of spatial-element frames comprises both non-inter-coded spatial-element frames (152) and inter-coded spatial-element frames (151). The request identifies the spatial element and specifies a starting point (179) corresponding substantially to a current time. The request is for data comprising a temporal segment of high-resolution spatial-element frames starting substantially at the starting point (179) and of which the first high-resolution spatial-element frame (173) is not inter coded. The method further comprises the client device receiving the requested data.

### FIELD OF THE INVENTION

The invention relates to methods of transmitting a request for video data and methods of transmitting video data.

The invention further relates to a client device for transmitting a request for video data and a distribution node for transmitting video data.

The invention also relates to a computer program product and a signal enabling a computer system to perform such methods.

### BACKGROUND OF THE INVENTION

The increasing availability and use of Virtual Reality headsets has given rise to cameras that support new video formats, such as those that can record full 360-degree spherical video (often referred to as VR360 or 360VR video). Content recorded by such cameras is not only consumed in VR headsets, but is also made available on regular displays, where users can use their fingers, gestures or their mouse to navigate in the video.

Collectively referred to as ‘immersive’ video, there exists a wide variety of such new video formats, with more variants reaching the market every day. Some of these are cylindrical versus spherical in nature. Others record in 180 or 270 degree instead of the full 360. There are several different approaches to 3D, with some cameras being monoscopic, others stereoscopic and even others being partially stereoscopic (with only a certain area of the video being recorded stereoscopically, with the rest recorded monoscopically).

Regardless of the exact format, what binds these different content formats together is the fact that a user typically only views a small area of the video at any given time. With a significant percentage of immersive video being viewed through VR headsets, where the display is very close to the human eye, the resolution of the recorded video needs to be very high in order to not come across as pixelated (and thus low quality) to the end user. This poor quality seriously impedes the end-user quality of experience.

For traditional video being displayed on a smartphone or tablet, HD resolutions (1920×1080 pixels) are considered to be sufficient for the user to not being able to notice individual pixels. Large TVs screens obviously need a higher resolution when viewed up close, which is the reason newer TVs typically support Ultra HD (3840×2160 pixels; also referred to as 4K, because it has roughly 4000 horizontal pixels) resolutions. Even higher resolutions are generally considered to be unnoticeable to end users.

The same cannot be said for VR headsets though. Due to the closeness of the human eye to the display in a VR headset, the pixel size needs to be much smaller for the user not to be able to discern them. Because of this, the resolution of VR displays, and thus the content being shown on them, needs to be of significantly higher quality (resolution). Research has suggested that a VR headset will need to display video at roughly 8 k horizontal pixels per eye (making the total display resolution 8 times UHD, or 32 times HD) for the individual pixels to no longer be visible to the end user. And given that users only ever see a small part of a 360-degree video at the same time, this means that the total resolution being recorded will need to be in the order of 32000 pixels horizontally and 16000 vertically (32 k×16 k), so two orders of magnitude higher than what most traditional video content is being recorded at today. While today's cameras are not able to record 32K video, 8K and 12K cameras are starting to become available.

The primary factor limiting immersive video quality however, is not so much the camera technology, but the distribution technology. Sending traditional UHD video, or even high-quality HD, over the current internet, is not only very complex and expensive, it is also limited to those countries and users that have a sufficiently fast internet connection. With immersive video requiring an even higher quality video, distribution of immersive media is a big challenge.

There currently exists a variety of distribution methods for delivering immersive video. The first and most-used at this moment is also the simplest one, which is simply delivering the immersive video to the client as if it were a normal traditional video. This means the full spherical video is being delivered to the client, decoded on the end-user device, and projected on the VR headset. The advantage of this method is that it re-uses existing technology and distribution methods, and that no new techniques are required. The downside is that it is either very expensive in terms of bandwidth (given that an immersive video will typically be of higher resolution than a traditional video), which will reduce reach and increase cost, or low in quality (if the quality is degraded to accommodate for lower bandwidth).

A second group of approaches, and one that is increasingly explored in the research community, is also referred to as ‘viewport-adaptive streaming’. While there exist several different approaches for viewport-adaptive streaming, each with its own advantages and drawbacks, the most scalable and promising is called tiled streaming. Tiled streaming is described in US 2017/0155912 A1, for example. With tiled streaming, the original immersive video (whether it is cylindrical, spherical, or otherwise) is split up into individual spatial elements and each frame of the video is split up into individual spatial-element frames. Since the spatial-elements are rectangles, the spatial elements and/or the spatial-element frames are referred to as “tiles”. Each spatial-element frame is then independently encoded in such a way that it can be successfully decoded on the client side without the client requiring access to the other spatial-element frames. By successively retrieving individual spatial-element frames based on the user's field of view, the client is able to only retrieve and decode the area of the video that the user is interested in. By only streaming the area of the immersive video that the user is interested in, the total bandwidth necessary to distribute the immersive video can be reduced significantly. This reduction in bandwidth can either be used to increase reach (meaning a higher percentage of users will have sufficient bandwidth to receive the streaming video) and reduce cost (less bits transferred), or to increase quality, or to achieve a combination of these goals. By only sending a small portion of the video at any given time, that region can be sent at a higher quality than would normally have been possible without increasing bandwidth.

A drawback of this approach is the time it takes for the client to retrieve the appropriate spatial-element frames from the network when the user turns his head. The end to end latency between the user turning his head and the spatial-element frames being fetched from the network and displayed in the headset, also referred to as the motion-to-photon latency, significantly impacts the Quality of Experience (QoE). Latencies as little as 100 milliseconds can already make for a lower user QoE.

Most tiled streaming approaches discussed in the state-of-the-art are based on, or are an extension of, HTTP Adaptive Streaming. With HTTP Adaptive Streaming, of which MPEG DASH and Apple HLS are the dominant examples, a video stream is cut up into temporal elements, called segments, each typically between 3 and 30 seconds long. When watching a video, a client sequentially fetches successive segments from the network via standard HTTP, buffers them, and feeds them to the video decoder. Where HTTP Adaptive Streaming gets its name from is that each segment can be made available in multiple different qualities/resolutions (called “representations”), with the client able to switch between the different qualities based on the available bandwidth. Switching quality (due to changing network link conditions) would typically happen at segment boundaries.

When applied to tiled streaming, each spatial element is typically represented as an independent video stream, where each spatial element is itself split up into multiple temporal segments of spatial-element frames. A common manifest file [e.g. DASH-SRD: ISO/IEC 23009-1:2014], or container format then contains pointers to the individual segments of spatial-element frames and describes their temporal and spatial relationship. From a client point of view, the client first downloads and parses the manifest file and then sets up multiple HTTP Adaptive Streaming sessions, one for each spatial element. Each session will consist of sequentially downloading successive segments. When a user turns his head, the HTTP Adaptive Streaming sessions for those spatial elements no longer in the field of view will be cancelled, and new ones will be started for the spatial elements that just entered the field of view.

While HTTP Adaptive Streaming is well suited for traditional video streaming, it is less suited for tiled streaming, primarily because of latency. When a user turns his head with a VR headset, the human vestibular system expects the view captured by the eyes to move along accordingly. When this doesn't happen, or doesn't happen fast enough, motion sickness occurs very quickly. Research has shown that this problem already occurs if the delay between head movement and the eyes registering the appropriate movement is more than 8-10 ms. This means that spatial-element frames need to be retrieved very fast, or that some visual information is needed that is always present and that can be displayed in a way that is consistent with a user's head movement.

Given that 8-10 ms is an extremely short time for a system to respond to sensor data, fetch video data over the internet, decode that data and show it to the end-user, this is typically not achieved in HTTP Adaptive Streaming-based tiled streaming solutions. It is possible to work around this by 1) always downloading a field of view that is larger than that which is experienced by the end-user, thereby creating a sort of spatial buffer, and 2) always streaming a low-resolution fallback/base layer that can be shown while the system waits for the high-resolution tiles to arrive.

While this approach works, it has two significant drawbacks. First, creating a spatial buffer that contains data outside the field of view of the user goes directly against the entire idea of tiled streaming, which was to reduce required bandwidth by only downloading that part of the viewport which is necessary. In other words, it reduces the gains made by using a tiled streaming solution in the first place. Second, while a low-resolution fallback at least shows the user some visuals to reduce or eliminate motion-sickness by keeping the motion-to-photon latency at a minimum, watching a low-quality stream for a significant period of time (e.g. anything more than a 100 ms or so) every time a user moves his head is not a particularly good quality of experience, especially because users tend to move their head frequently when consuming immersive video. In this situation, the motion-to-photon latency is sufficient, but the “motion-to-high-res” latency, i.e. the end to end latency between the user turning his head and the high-resolution spatial-element frames being fetched from the network and displayed in the headset, is often insufficient.

### SUMMARY OF THE INVENTION

It is a first object of the invention to provide a method of transmitting a request for video data, which helps a client device receive high-resolution spatial-element frames fast enough to achieve a low motion-to-high-res latency.

It is a second object of the invention to provide a method of transmitting video data, which helps a client device receive high-resolution spatial-element frames fast enough to achieve a low motion-to-high-res latency.

It is a third object of the invention to provide a client device for transmitting a request for video data, which helps the client device receive high-resolution spatial-element frames fast enough to achieve a low motion-to-high-res latency.

It is a fourth object of the invention to provide a distribution node for transmitting video data, which helps a client device receive high-resolution spatial-element frames fast enough to achieve a low motion-to-high-res latency.

In a first aspect of the invention, the method of transmitting a request for video data comprises: a) for each spatial element of a video in a user's field of view for which a client device does not possess a current high-resolution spatial-element frame, said client device transmitting one or more requests for high-resolution spatial-element frames of said spatial element of said video to a distribution node, said video comprising a plurality of spatial elements and a plurality of spatial-element frames for each of said plurality of spatial elements, said plurality of spatial-element frames comprising both non-inter-coded spatial-element frames and inter-coded spatial-element frames, said one or more requests identifying said spatial element and specifying a starting point corresponding substantially to a current time and said one or more requests being for data comprising a temporal segment of high-resolution spatial-element frames starting substantially at said starting point, the first high-resolution spatial-element frame of said temporal segment of high-resolution spatial-element frames not being inter coded, and b) for each of said spatial elements for which said one or more requests is transmitted, said client device receiving data relating to said spatial element of said video from said distribution node in response to said one or more requests, said data comprising a temporal segment of high-resolution spatial-element frames starting substantially at said starting point, said high-resolution spatial-element frames of said temporal segment each comprising a plurality of video pixels, the first one or more high-resolution spatial-element frames of said temporal segment of high-resolution spatial-element frames not being inter coded. Said method may be performed by software running on a programmable device. This software may be provided as a computer program product.

A single request may specify one or more spatial elements. Thus, the invention allows, but does not require a separate request to be transmitted for each of the spatial elements. Preferably, a single request is for multiple spatial-element frames. Said starting point may be specified as a point in time, a temporal index value or a position in a file, for example. The non-inter-coded first one or more spatial-element frames of the temporal segment of spatial-element frames may originate from a group of spatial-element frames which comprises only non-inter-coded spatial-element frames or from a group of spatial-element frames which comprises inter-coded spatial-element frames as well as one or more non-inter-coded spatial-element frames. The distribution node may be an origin node or a cache node, for example. The spatial elements may be rectangular or some or all spatial elements may have a different shape, e.g. an ellipse shape.

A spatial-element frame is current if it should be displayed currently. If a spatial-element frame cannot be displayed currently, it should preferably be displayed within 8-10 ms after a change in the user's field of view is requested in order to achieve a low motion-to-photon latency. A high-resolution spatial-element frame should preferably be displayed within 100 ms in order to achieve a low motion-to-high-res latency. Since a frame is typically obsolete after 40 ms (25 fps) or 33.33 ms (30 fps), upscaled versions of low-resolution spatial-element frames from a fallback layer may be displayed if the requested one or more high-resolution spatial-element frames are not received before the next spatial-element frame needs to be displayed. If a client device does not possess the current high-resolution spatial-element frame for a spatial element and has not requested the current high-resolution spatial-element frame, the client device will normally not possess the high-resolution spatial-element frame immediately preceding the current high-resolution spatial-element frame for this spatial element. A high-resolution spatial-element frame has a higher resolution than a low-resolution spatial-element frame.

The inventors have recognized that a significant factor contributing to the high motion-to-high-res latency is the fact that often more high-resolution spatial-element frames are retrieved than necessary. The contribution of this factor to the latency increases with an increasing Group of Pictures (GoP) size. To prevent that more high-resolution spatial-element frames are transmitted to the client device than necessary, the client device should be able to specify a starting point in the request for high-resolution spatial-element frames of a certain spatial element and request that the first high-resolution spatial-element frame of the temporal segment(s) to be received has not been inter coded so that one or more preceding high-resolution spatial-element frames are not required for decoding the first high-resolution spatial-element frame. Non-inter-coded spatial-element frames are spatial-element frames which are not encoded temporally, but only spatially (i.e. intra-coded), e.g. I-frames. Inter-coded spatial-element frames are spatial-element frames which are encoded spatially as well as temporally, e.g. P-frames or B-frames. P-frames can comprise predicted macroblocks. B-frames can comprise predicted and bi-predicted macroblocks. The one or more requests should at least be transmitted for each spatial element in a user's field of view for which the client device does not possess a current high-resolution spatial-element frame in order to achieve a low motion-to-high-res latency.

Said starting point may be specified as a position in a file and said file may comprise two or more temporal segments of high-resolution spatial-element frames relating to at least partly overlapping time periods for a plurality of time periods, at least a first one of said two or more temporal segments of high-resolution spatial-element frames comprising inter-coded spatial-element frames and at least a second one of said two or more temporal segments of spatial-element frames comprising only non-inter-coded spatial-element frames, said two or more temporal segments being stored near each other in said file. By having the client device specify the starting position as a position in a file, e.g. in an HTTP byte-range request, most of the intelligence may be placed in the client device. This allows distribution nodes to process requests for more users with the same hardware. By organizing the file as specified above, the way Content Delivery Networks caches work can be exploited in order to increase the chances that the requested non-inter-coded spatial-element frame is cached, thereby decreasing the time it takes to retrieve this non-inter-coded spatial-element frame, and thus the motion-to-high-res latency, even further.

Large scale content distribution over the internet is generally carried out through Content Delivery Networks, or CDNs. A CDN architecture typically consists of a minimum of two layers, with the lowest layer consisting of CDN edge caches that are placed relatively close to end-users, and the highest layer consisting of the origin distribution node on which all content is stored and which is stored at a central location. Some, but not all, CDNs place one or more other layers between these two extremes to provide intermediate caching and reduce load on the origin.

The process of a client device retrieving data from a CDN is as follows: through a system of redirection, the initial request for data ends up at a CDN edge node close to the location of the client. The edge node checks whether the requested data is in its cache and, if so, responds with the data. If the data is not in the cache, the edge node contacts the next, higher layer in the CDN architecture for the data. Once the request arrives at a point where the data is available (with the origin being the final location), the data trickles back to the edge node which then forwards it back to the client.

From a latency point of view, the ideal situation is the CDN edge node already having cached the spatial-element frame required by the client. However, given the characteristics of tiled streaming (streaming of rectangular spatial-element frames), the chances of this happening will be relatively small compared to traditional video.

There are several reasons for this: 1) given that each client device normally only receives spatial-element frames of those spatial elements of the video that the user is viewing, the CDN edge node will only have cached those spatial-element frames of those spatial elements in the video that any particular user in the edge nodes serving area has accessed recently. Depending on the length and popularity of the content, the chances of every spatial-element frame of every spatial element having been streamed during the cache's cache window will be very slim except for the most popular content. 2) given the large total aggregate size of the immersive video compared to traditional content, and the relatively low frequency with which specific spatial-element frames of specific spatial elements are accessed, the CDN edge's caching strategy is more likely to purge (some) less frequently used spatial-element frame data relatively soon from its cache.

This problem is worsened by the fact that non-inter-coded spatial-element frames (e.g. I-frames) on which no other spatial-element frame (e.g. B-frame or P-frame) depends will normally be accessed relatively infrequently, which means that the probability that the second one of the two or more temporal segments of spatial-element frames, comprising only non-inter-coded spatial-element frames, is cached is likely even lower. When data for a given request is not cached, the CDN edge node will first have to retrieve the data from the origin, or another higher layer entity, which will significantly impact the time it takes to retrieve the data, and therefore the motion-to-high-res latency. Since the probability that the second one of the two or more temporal segments of spatial-element frames is cached in the CDN edge node is low, there is a significant chance of that data having to come from a higher-layer CDN node, and therefore resulting in a higher motion-to-high-res latency.

By storing the two or more temporal segments near each other in the file, the way CDN caches work, and the way they handle HTTP byte range requests, can be exploited. An HTTP Byte Range Request can be of arbitrary size, from requesting a single byte to an open-ended request where transfer is started from a certain byte range offset up until the file or the connection ends. However, given that both these extremes pose challenges for the communication between a CDN edge node and the higher layer CDN nodes, a byte range request is typically transformed before it is passed up to a higher layer CDN node in case of a cache miss. Most CDNs do this by working with fixed size chunks between the different nodes, e.g. of 2000 Kbyte (or 2 Mbyte). This will be referred to as “CDN chunking behavior”. For example, when a client requests bytes 200-850 and there is a cache miss, the CDN cache may request bytes 0-2000 k from the origin, while only sending bytes 200-850 on to the client. Similarly, still assuming a 2 Mbyte internal chunk size, when requesting bytes 1980 k-2010 k, the CDN edge node may request 0-4000 k from the origin.

How near said two or more temporal segments should preferably be stored in said file depends on the configured CDN chunking behavior and the size of the temporal segments. The size of the temporal segments may also depend on the configured CDN chunking behavior. For example, when temporal segments of spatial-element frames relating to at least partly overlapping time periods are stored (and therefore transmitted) sequentially and two or three consecutive temporal segments fit into one chunk, this should already substantially increase the probability that a requested non-inter-coded spatial-element frame is cached.

Said method may further comprise determining said starting point by looking up a position in a file by using an index associated with said file, said position corresponding substantially to a current time and said index comprising a mapping from a point in time or a temporal index value to a position in said file. By having the client device specify the starting position as a position in a file, e.g. in an HTTP byte-range request, most of the intelligence may be placed in the client device. This allows distribution nodes, e.g. a streaming server, to process requests for more users with the same hardware. The index allows the client device to determine a starting position based on a point in time (e.g. hours, minutes, seconds and milliseconds elapsed after the start of the video) or a temporal index value (e.g. a counter of frames of the video that have been displayed).

Determining said starting point may comprise selecting one index from a plurality of indices associated with one or more files, said one or more files including said file, said plurality of indices each comprising a mapping from a point in time or a temporal index value to a position in said one or more files, and looking up said position in said one or more files by using said selected index, said position corresponding to a position of a non-inter-coded spatial-element frame in said one or more files. When the file comprises two or more temporal segments of high-resolution spatial-element frames relating to at least partly overlapping time periods for a plurality of time periods, as previously described, multiple indices are preferably used. The plurality of indices may be stored in the same index file, for example.

Said method may further comprise, for at least one of said spatial elements for which said one or more requests is transmitted, said client device transmitting one or more further requests for further high-resolution spatial-element frames of said spatial element of said video to said distribution node, said one or more further requests identifying said spatial element and specifying a further starting point corresponding substantially to a current time, and determining said further starting point by looking up a position in a file by using another one of said plurality of indices. In this way, an I-frame-only stream, i.e. a stream comprising only non-inter-coded frames, can be used for the (first) request and a main stream, i.e. a stream comprising both non-inter-coded and inter-coded frames, can be used for the further request(s).

The method may further comprise displaying said received high-resolution spatial-element frames, pausing display of said video upon receiving an instruction to pause display of said video, upon receiving said instruction, for each spatial element of said video outside said user's field of view for which a client device does not possess a current high-resolution spatial-element frame, said client device transmitting one or more further requests for high-resolution spatial-element frames of said spatial element, receiving further high-resolution spatial-element frames in response to said further requests, and displaying at least one of said received further high-resolution spatial-element frames upon receiving an instruction to change said user's field of view while said display of said video is being paused. This makes it possible for the user to change his field of view (e.g. in a 360-degree video) without deteriorating his experience with (many) low-resolution spatial-element frames.

The method may further comprise, for each spatial element of said video, said client device transmitting one or more further requests for low-resolution spatial-element frames of said spatial element of said video, receiving low-resolution spatial-element frames in response to said further requests, a) displaying a current low-resolution spatial-element frame for each spatial element in said user's field of view for which said client device does not possess a current high-resolution spatial-element frame (e.g. if the high-resolution spatial-element frame is not (yet) available), b) displaying a current high-resolution spatial-element frame for one or more spatial elements in said user's field of view for which said client device possesses said current high-resolution spatial-element frame (e.g. if a spatial element has been in the user's field of view for a while and no spatial-element frame has been delayed or lost), and c) displaying a current low-resolution spatial-element frame for one or more further spatial elements in said user's field of view for which said client device possesses a current high-resolution spatial-element frame (e.g. if a spatial element has been in the user's field of view for a while and a spatial-element frame has been delayed or lost).

Using a current low-resolution spatial-element frame instead of a current high-resolution spatial-element frame may not only be beneficial when the client device does not possess the current high-resolution spatial-element frame, but also when the client device does possess the current high-resolution spatial-element frame. For example, displaying the current low-resolution spatial-element frame instead of the current high-resolution spatial-element frame may be beneficial when the high-resolution spatial-element frame depends on another high-resolution spatial-element frame and the client device does not possess this other high-resolution spatial-element frame (e.g. because it has been delayed or lost), which would result in the current high-resolution spatial-element frame being decoded with artefacts.

The method may further comprise rewriting metadata in a bitstream comprising said temporal segment of high-resolution spatial-element frames, and (upscaled) low-resolution spatial-element frames if applicable, to make said bitstream valid. This prevents the decoder from not being able to handle the spatial-element frames. A bitstream is valid when it can be decoded without errors by the decoder.

In a second aspect of the invention, the method of transmitting video data comprises receiving a request to obtain a part of a file from a requestor, said request identifying said file and specifying a starting position, said file comprising a plurality of spatial-element frames of a spatial element of a compressed video, said compressed video comprising a plurality of spatial elements, locating said file in a memory, obtaining data from said file located in said memory starting at said specified starting position, said data comprising two or more temporal segments of spatial-element frames relating to at least partly overlapping time periods, said spatial-element frames of said two or more temporal segments each comprising a plurality of video pixels, at least a first one of said two or more temporal segments of spatial-element frames comprising inter-coded spatial-element frames and at least a second one of said two or more temporal segments of spatial-element frames comprising only non-inter-coded spatial-element frames, said two or more temporal segments being located near each other in said data, and transmitting said data to said requestor. Said method may be performed by software running on a programmable device. This software may be provided as a computer program product.

Said request may further specify an ending position and said data may be obtained from said specified starting position until said specified ending position. This advantageously prevents that more data is transmitted than necessary, e.g. a further temporal segment comprising only non-inter-coded spatial-element frames that is not needed, and/or allows bandwidth usage to be controlled.

Said two or more temporal segments of spatial-element frames may be stored sequentially in said file. Sequentially storing the two or more temporal segments of spatial-element frames may be used to ensure that they are stored near each other.

Said first one of said two or more temporal segments of spatial-element frames may comprise, for example, at most one or two non-inter-coded spatial-element frames. By alternating each one or two regular Group of Pictures comprising an I-frame and several P-frames with a temporal segment comprising only I-frames, for example, the temporal segments will normally have an appropriate size to benefit from the afore-mentioned CDN chunking behaviour. Said two or more temporal segments of spatial-element frames may substantially correspond to the same uncompressed video data.

Said request may specify a further starting position and said method may further comprise obtaining further data from said file located in said memory starting at said specified further starting position, said further data comprising two or more further temporal segments of spatial-element frames relating to at least partly overlapping time periods, said spatial-element frames of said two or more further temporal segments each comprising a plurality of video pixels, at least a first one of said two or more further temporal segments of spatial-element frames comprising inter-coded spatial-element frames and at least a second one of said two or more further temporal segments of spatial-element frames comprising only non-inter-coded spatial-element frames, and transmitting said further data to said requestor. In this way, the requestor, e.g. the client device or the CDN edge node, may request a plurality of temporal segments corresponding to non-overlapping time periods at the same time, thereby reducing the number of requests. This is beneficial, because there is a cost involved with each request, both in time as well as in bytes (e.g. each request may carry several HTTP headers).

In a third aspect of the invention, the signal comprises two or more temporal segments of spatial-element frames relating to at least partly overlapping time periods, said two or more temporal segments belonging to a spatial element of a compressed video, said compressed video comprising a plurality of spatial elements, said spatial-element frames of said two or more temporal segments each comprising a plurality of video pixels, at least a first one of said two or more temporal segments of spatial-element frames comprising inter-coded spatial-element frames and at least a second one of said two or more temporal segments of spatial-element frames comprising only non-inter-coded spatial-element frames, said two or more temporal segments being located near each other in said signal.

In a fourth aspect of the invention, the client device comprises at least one transmitter, at least one receiver, and at least one processor configured to: a) for each spatial element of a video in a user's field of view for which said client device does not possess a current high-resolution spatial-element frame, use said at least one transmitter to transmit one or more requests for high-resolution spatial-element frames of said spatial element of said video to a distribution node, said video comprising a plurality of spatial elements and a plurality of spatial-element frames for each of said plurality of spatial elements, said plurality of spatial-element frames comprising both non-inter-coded spatial-element frames and inter-coded spatial-element frames, said one or more requests identifying said spatial element and specifying a starting point corresponding substantially to a current time and said one or more requests being for data comprising a temporal segment of high-resolution spatial-element frames starting substantially at said starting point, the first high-resolution spatial-element frame of said temporal segment of high-resolution spatial-element frames not being inter coded, and b) for each of said spatial elements for which said one or more requests is transmitted, use said at least one receiver to receive data relating to said spatial element of said video from said distribution node in response to said one or more requests, said data comprising a temporal segment of high-resolution spatial-element frames starting substantially at said starting point, said high-resolution spatial-element frames of said temporal segment each comprising a plurality of video pixels, the first one or more high-resolution spatial-element frames of said temporal segment of high-resolution spatial-element frames not being inter coded.

In a fifth aspect of the invention, the distribution node comprises at least one receiver, at least one transmitter, and at least one processor configured to use said at least one receiver to receive a request to obtain a part of a file from a requestor, said request identifying said file and specifying a starting position, said file comprising a plurality of spatial-element frames of a spatial element of a compressed video, said compressed video comprising a plurality of spatial elements, locate said file in a memory, obtain data from said file located in said memory starting at said specified starting position, said data comprising two or more temporal segments of spatial-element frames relating to at least partly overlapping time periods, said spatial-element frames of said two or more temporal segments each comprising a plurality of video pixels, at least a first one of said two or more temporal segments of spatial-element frames comprising inter-coded spatial-element frames and at least a second one of said two or more temporal segments of spatial-element frames comprising only non-inter-coded spatial-element frames, said two or more temporal segments being located near each other in said data, and use said at least one transmitter to transmit said data to said requestor.

In a sixth aspect of the invention, the method of transmitting video data comprises receiving a request to start streaming spatial-element frames of a spatial element of a compressed video from a requestor, said compressed video comprising a plurality of spatial elements and said request identifying said spatial element and specifying a temporal starting point, obtaining data relating to said spatial element of said compressed video by obtaining a portion of a first temporal segment and obtaining a second temporal segment succeeding said first temporal segment, said first temporal segment comprising a certain spatial-element frame corresponding to said temporal starting point and said first temporal segment comprising only non-inter-coded spatial-element frames, said second temporal segment comprising a plurality of inter-coded spatial-element frames and said portion of said first temporal segment starting with said certain spatial-element frame, said spatial-element frames of said first and second temporal segments each comprising a plurality of video pixels, and transmitting said data to said requestor. Said method may be performed by software running on a programmable device. This software may be provided as a computer program product.

In case it is necessary or beneficial to place more intelligence in the distribution node, the distribution node may actively ensure that the first spatial-element frame transmitted to the requestor is a non-inter-coded spatial-element frame by obtaining non-inter-coded spatial-element frames from the first temporal segment, starting with a spatial-element frame at the temporal starting position. The first temporal segment may comprise non-inter-coded versions of the inter-coded spatial-element frames of the temporal segment preceding the second temporal segment, for example. Said temporal starting point may be specified as a point in time or a temporal index, for example.

Said first temporal segment and said second temporal segment may be stored in a single file in a memory and said file may comprise two or more temporal segments of spatial-element frames relating to at least partly overlapping time periods for a plurality of time periods, at least a first one of said two or more temporal segments of spatial-element frames comprising inter-coded spatial-element frames and at least a second one of said two or more temporal segments of spatial-element frames comprising only non-inter-coded spatial-element frames. The same file organization that increases the probability that a requested non-inter-coded spatial-element frame is cached, as previously described, may be used when more intelligence is placed in the distribution node, albeit without the benefit of increasing the probability that a requested non-inter-coded spatial-element frame is cached.

In a seventh aspect of the invention, the distribution node comprises at least one receiver, at least one transmitter, and at least one processor configured to use said at least one receiver to receive a request to start streaming spatial-element frames of a spatial element of a compressed video from a requestor, said compressed video comprising a plurality of spatial elements and said request identifying said spatial element and specifying a temporal starting point, obtain data relating to said spatial element of said compressed video by obtaining a portion of a first temporal segment and obtaining a second temporal segment succeeding said first temporal segment, said first temporal segment comprising a certain spatial-element frame corresponding to said temporal starting point and comprising only non-inter-coded spatial-element frames, said second temporal segment starting with a non-inter-coded spatial-element frame and comprising a plurality of inter-coded spatial-element frames and said portion of said first temporal segment starting with said certain spatial-element frame, said spatial-element frames of said first and second temporal segments each comprising a plurality of video pixels, and use said at least one transmitter to transmit said data to said requestor.

In an eighth aspect of the invention, the method of transmitting a request for video data comprises, for each spatial element of a video in a user's field of view, a client device transmitting one or more requests for high-resolution spatial-element frames of a spatial element of said video, said video comprising a plurality of spatial elements and a plurality of spatial-element frames for each of said plurality of spatial elements, receiving high-resolution spatial-element frames in response to said requests, displaying said received high-resolution spatial-element frames, pausing display of said video upon receiving an instruction to pause display of said video, upon receiving said instruction, for each spatial element of said video outside said user's field of view for which a client device does not possess a current high-resolution spatial-element frame, said client device transmitting one or more further requests for high-resolution spatial-element frames of said spatial element, receiving further high-resolution spatial-element frames in response to said further requests, and displaying one or more of said received further high-resolution spatial-element frames upon receiving an instruction to change said user's field of view while said display of said video is being paused.

This makes it possible for the user to change his field of view (e.g. in a 360-degree video) without deteriorating his experience with (many) low-resolution spatial-element frames. Said method may be performed by software running on a programmable device. This software may be provided as a computer program product. This eighth aspect of the invention may be used with or without using the first aspect of the invention. However, without using the first aspect of the invention, the client device may not be able to receive high-resolution spatial-element frames fast enough to achieve a low motion-to-high-res latency.

The method may further comprise rewriting metadata in a bitstream comprising said one or more of said received further high-resolution spatial-element frames, and (upscaled) low-resolution spatial-element frames if applicable, to make said bitstream valid. This prevents the decoder from not being able to handle the spatial-element frames.

The method may further comprise rewriting an index number of said one or more received further high-resolution spatial-element frames, and (upscaled) low-resolution spatial-element frames if applicable, in said metadata before passing said bitstream to a decoder. This prevents the decoder from not being able to handle the spatial-element frames due to them having an index number which is out of order, e.g. the same index number as a frame which has already been decoded. Said index number may comprise a Picture Order Count (POC) value, e.g. when the bitstream is AVC or HEVC compliant.

In a ninth aspect of the invention, the client device comprises at least one transmitter, at least one receiver, and at least one processor configured to, for each spatial element of a video in a user's field of view, use said at least one transmitter to transmit one or more requests for high-resolution spatial-element frames of a spatial element of said video, said video comprising a plurality of spatial elements and a plurality of spatial-element frames for each of said plurality of spatial elements, use said at least one receiver to receive high-resolution spatial-element frames in response to said requests, display said received high-resolution spatial-element frames, pause display of said video upon receiving an instruction to pause display of said video, upon receiving said instruction, for each spatial element of said video outside said user's field of view for which a client device does not possess a current high-resolution spatial-element frame, use said at least one transmitter to transmit one or more further requests for high-resolution spatial-element frames of said spatial element, use said at least one receiver to receive further high-resolution spatial-element frames in response to said further requests, and display at least one of said received further high-resolution spatial-element frames upon receiving an instruction to change said user's field of view while said display of said video is being paused

In a tenth aspect of the invention, the method of transmitting a request for video data comprises, for each spatial element of a video in a user's field of view, a client device transmitting one or more requests for high-resolution spatial-element frames of a spatial element of said video, said video comprising a plurality of spatial elements and a plurality of spatial-element frames for each of said plurality of spatial elements, said plurality of spatial-element frames comprising both non-inter-coded spatial-element frames and inter-coded spatial-element frames, receiving high-resolution spatial-element frames in response to said requests, for each spatial element of said video, said client device transmitting one or more further requests for low-resolution spatial-element frames of said spatial element of said video, receiving low-resolution spatial-element frames in response to said further requests, displaying a current low-resolution spatial-element frame for each spatial element in said user's field of view for which said client device does not possess a current high-resolution spatial-element frame, displaying a current high-resolution spatial-element frame for one or more spatial elements in said user's field of view for which said client device possesses said current high-resolution spatial-element frame, and displaying a current low-resolution spatial-element frame for one or more further spatial elements in said user's field of view for which said client device possesses a current high-resolution spatial-element frame.

Using a current low-resolution spatial-element frame instead of a current high-resolution spatial-element frame may not only be beneficial when the client device does not possess the current high-resolution spatial-element frame, but also when the client device does possess the current high-resolution spatial-element frame, e.g. when the high-resolution spatial-element frame depends on another spatial-element frame and the client devices does not possess this other spatial-element frame. Said method may be performed by software running on a programmable device. This software may be provided as a computer program product. This tenth aspect of the invention may be used with or without using the first aspect and/or eighth aspect of the invention. However, without using the first aspect of the invention, the client device may not be able to receive high-resolution spatial-element frames fast enough to achieve a low motion-to-high-res latency.

A current low-resolution spatial-element frame may be displayed for a further spatial element in said user's field of view for which said client device possesses a current high-resolution spatial-element frame if said current high-resolution spatial-element frame is inter-coded and said client device does not possess a previous non-inter-coded high-resolution spatial-element frame on which said current high-resolution spatial-element frame depends. When the client device does not possess this spatial-element frame, decoding said current high-resolution spatial-element frame will often result in a low quality decoded frame.

A current high-resolution spatial-element frame may be displayed for a further spatial element in said user's field of view for which said client device possesses said current high-resolution spatial-element frame if said current high-resolution spatial-element frame is inter-coded, said client device possesses a previous non-inter-coded high-resolution spatial-element frame on which said current high-resolution spatial-element frame depends and said client device does not possess one or multiple inter-coded high-resolution spatial-element frames on which said current high-resolution spatial-element frame depends. Decoding said current high-resolution spatial-element frame may still result in a higher quality decoded frame than decoding said current low-resolution spatial-element frame in this case.

A current low-resolution spatial-element frame may be displayed for a further spatial element in said user's field of view for which said client device possesses a current high-resolution spatial-element frame if decoding said current high-resolution spatial-element frame is assessed to result in a lower quality decoded frame than decoding said current low-resolution spatial-element frame. By actually assessing the current high-resolution spatial-element frame, the best spatial-element frame can be selected in most or all situations.

In an eleventh aspect of the invention, the client device comprises at least one transmitter, at least one receiver, and at least one processor configured to, for each spatial element of a video in a user's field of view, use said at least one transmitter to transmit one or more requests for high-resolution spatial-element frames of a spatial element of said video, said video comprising a plurality of spatial elements and a plurality of spatial-element frames for each of said plurality of spatial elements, said plurality of spatial-element frames comprising both non-inter-coded spatial-element frames and inter-coded spatial-element frames, use said at least one receiver to receive high-resolution spatial-element frames in response to said requests, for each spatial element of said video, use said at least one transmitter to transmit one or more further requests for low-resolution spatial-element frames of said spatial element of said video, use said at least one receiver to receive low-resolution spatial-element frames in response to said further requests, display a current low-resolution spatial-element frame for each spatial element in said user's field of view for which said client device does not possess a current high-resolution spatial-element frame, display a current high-resolution spatial-element frame for one or more spatial elements in said user's field of view for which said client device possesses said current high-resolution spatial-element frame, and display a current low-resolution spatial-element frame for one or more further spatial elements in said user's field of view for which said client device possesses a current high-resolution spatial-element frame.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations comprising: a) for each spatial element of a video in a user's field of view for which a client device does not possess a current high-resolution spatial-element frame, said client device transmitting one or more requests for high-resolution spatial-element frames of said spatial element of said video to a distribution node, said video comprising a plurality of spatial elements and a plurality of spatial-element frames for each of said plurality of spatial elements, said plurality of spatial-element frames comprising both non-inter-coded spatial-element frames and inter-coded spatial-element frames, said one or more requests identifying said spatial element and specifying a starting point corresponding substantially to a current time and said one or more requests being for data comprising a temporal segment of high-resolution spatial-element frames starting substantially at said starting point, the first high-resolution spatial-element frame of said temporal segment of high-resolution spatial-element frames not being inter coded, and b) for each of said spatial elements for which said one or more requests is transmitted, said client device receiving data relating to said spatial element of said video from said distribution node in response to said one or more requests, said data comprising a temporal segment of high-resolution spatial-element frames starting substantially at said starting point, said high-resolution spatial-element frames of said temporal segment each comprising a plurality of video pixels, the first one or more high-resolution spatial-element frames of said temporal segment of high-resolution spatial-element frames not being inter coded.

A non-transitory computer-readable storage medium stores at least a second software code portion, the second software code portion, when executed or processed by a computer, being configured to perform executable operations comprising: receiving a request to obtain a part of a file from a requestor, said request identifying said file and specifying a starting position, said file comprising a plurality of spatial-element frames of a spatial element of a compressed video, said compressed video comprising a plurality of spatial elements, locating said file in a memory, obtaining data from said file located in said memory starting at said specified starting position, said data comprising two or more temporal segments of spatial-element frames relating to at least partly overlapping time periods, said spatial-element frames of said two or more temporal segments each comprising a plurality of video pixels, at least a first one of said two or more temporal segments of spatial-element frames comprising inter-coded spatial-element frames and at least a second one of said two or more temporal segments of spatial-element frames comprising only non-inter-coded spatial-element frames, said two or more temporal segments being stored near each other in said file, and transmitting said data to said requestor.

A non-transitory computer-readable storage medium stores at least a third software code portion, the third software code portion, when executed or processed by a computer, being configured to perform executable operations comprising: receiving a request to start streaming spatial-element frames of a spatial element of a compressed video from a requestor, said compressed video comprising a plurality of spatial elements and said request identifying said spatial element and specifying a temporal starting point, obtaining data relating to said spatial element of said compressed video by obtaining a portion of a first temporal segment and obtaining a second temporal segment succeeding said first temporal segment, said first temporal segment comprising a certain spatial-element frame corresponding to said temporal starting point and said first temporal segment comprising only non-inter-coded spatial-element frames, said second temporal segment comprising a plurality of inter-coded spatial-element frames and said portion of said first temporal segment starting with said certain spatial-element frame, said spatial-element frames of said first and second temporal segments each comprising a plurality of video pixels, and transmitting said data to said requestor.

A non-transitory computer-readable storage medium stores at least a fourth software code portion, the fourth software code portion, when executed or processed by a computer, being configured to perform executable operations comprising: for each spatial element of a video in a user's field of view, a client device transmitting one or more requests for high-resolution spatial-element frames of a spatial element of said video, said video comprising a plurality of spatial elements and a plurality of spatial-element frames for each of said plurality of spatial elements, receiving high-resolution spatial-element frames in response to said requests, displaying said received high-resolution spatial-element frames, pausing display of said video upon receiving an instruction to pause display of said video, upon receiving said instruction, for each spatial element of said video outside said user's field of view for which a client device does not possess a current high-resolution spatial-element frame, said client device transmitting one or more further requests for high-resolution spatial-element frames of said spatial element, receiving further high-resolution spatial-element frames in response to said further requests, and displaying one or more of said received further high-resolution spatial-element frames upon receiving an instruction to change said user's field of view while said display of said video is being paused.

A non-transitory computer-readable storage medium stores at least a fifth software code portion, the fifth software code portion, when executed or processed by a computer, being configured to perform executable operations comprising: for each spatial element of a video in a user's field of view, a client device transmitting one or more requests for high-resolution spatial-element frames of a spatial element of said video, said video comprising a plurality of spatial elements and a plurality of spatial-element frames for each of said plurality of spatial elements, said plurality of spatial-element frames comprising both non-inter-coded spatial-element frames and inter-coded spatial-element frames, receiving high-resolution spatial-element frames in response to said requests, for each spatial element of said video, said client device transmitting one or more further requests for low-resolution spatial-element frames of said spatial element of said video, receiving low-resolution spatial-element frames in response to said further requests, displaying a current low-resolution spatial-element frame for each spatial element in said user's field of view for which said client device does not possess a current high-resolution spatial-element frame, displaying a current high-resolution spatial-element frame for one or more spatial elements in said user's field of view for which said client device possesses said current high-resolution spatial-element frame, and displaying a current low-resolution spatial-element frame for one or more further spatial elements in said user's field of view for which said client device possesses a current high-resolution spatial-element frame.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(™), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the client device of the invention

FIG. 2 is a block diagram of a first embodiment of the distribution node of the invention;

FIG. 3 is a block diagram of a second embodiment of the distribution node of the invention;

FIG. 4 illustrates a tiled video streaming method in which no specific bytes of a file can be requested;

FIG. 5 depicts a conventional structure of a video segment;

FIG. 6 is a flow diagram of a first embodiment of the methods of the invention;

FIG. 7 is a flow diagram of a second embodiment of the method carried out by the client device;

FIG. 8 depicts a file comprising inter-coded spatial-element frames and a file comprising only non-inter-coded spatial-element frames;

FIG. 9 depicts indices for the files of FIG. 8;

FIG. 10 illustrates the methods of FIG. 6 being used with the files of FIG. 8;

FIG. 11 shows an example of spatial-elements which are in view and the different frame types being obtained for these spatial-elements;

FIG. 12 depicts an example of a file structure in which segments comprising inter-coded spatial-element frames and segments comprising only non-inter-coded spatial-element frames are interleaved;

FIG. 13 illustrates how the file structure of FIG. 12 makes use of the behavior of CDN cache nodes; and

FIG. 14 is a flow diagram of steps carried out by the client device for pausing display of a video;

FIG. 15 is a flow diagram of steps carried out by the client device for displaying spatial-element frames; and

FIG. 16 is a block diagram of an exemplary data processing system for performing the methods of the invention.

Corresponding elements in the drawings are denoted by the same reference numeral.

### DETAILED DESCRIPTION OF THE DRAWINGS

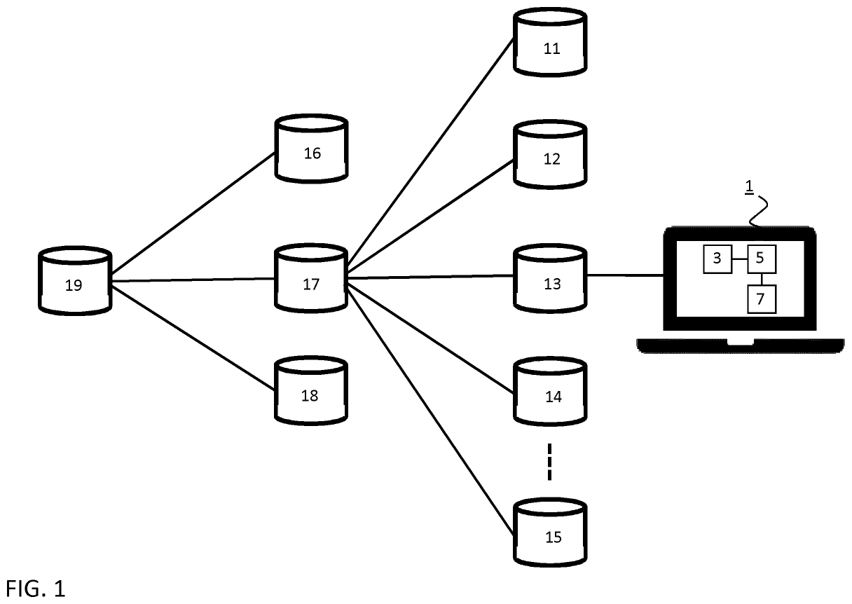

The client device 1 of the invention comprises a transceiver 3, a processor 5 and a memory 7, see FIG. 1. The processor 5 is configured to use the transceiver 3 to transmit one or more requests for high-resolution spatial-element frames of the spatial element of the video to a distribution node for each spatial element of a video in a user's field of view for which the client device does not possess a current high-resolution spatial-element frame. The video comprises a plurality of spatial elements and a plurality of spatial-element frames for each of the plurality of spatial elements. The plurality of spatial-element frames comprises both non-inter-coded spatial-element frames (e.g. I-frames) and inter-coded spatial-element frames (e.g. B and P frames). The one or more requests identify the spatial element and specify a starting point corresponding substantially to a current time and the one or more requests are for data comprising a temporal segment of high-resolution spatial-element frames starting substantially at the starting point. The first high-resolution spatial-element frame of the temporal segment of high-resolution spatial-element frames is not inter coded.

In the embodiment of FIG. 1, the client device 1 is connected to a content distribution network (CDN) and transmits the one or more requests addressed to the origin node 19. The one or more requests arrive at the edge cache 13, e.g. through redirection. The edge cache node 13 checks whether it can fulfill the one or more requests itself and transmits an own request for any spatial-element frames not in its cache to higher-layer cache node 17. The higher-layer cache node 17 checks whether it can fulfill the one or more requests itself and transmits an own request for any spatial-element frames not in its cache to origin node 19. The network shown in FIG. 1 comprises other distribution nodes than edge cache node 13, higher-layer cache node 17 and origin node 19. Edge cache nodes 11-12 and 14-15 and higher-layer cache nodes 16 and 17 are present, but are not in the path between client device 1 and origin node 19. In an alternative embodiment, the client device 1 is used in a network or network path without cache nodes. The edge cache nodes 11-14 may be the edge cache nodes for Ireland, Germany, France and Spain, for example. The higher-layer cache nodes 16-18 may be the higher-layer cache nodes for the U.S., Europe and Asia regions, for example.

The processor 5 is further configured to use the transceiver 3 to receive data relating to a spatial element of the video from the distribution node in response to the one or more requests for each of the spatial elements for which the one or more requests is transmitted. The data comprises a temporal segment of high-resolution spatial-element frames starting substantially at the starting point. The high-resolution spatial-element frames of the temporal segment each comprise a plurality of video pixels. The first one or more high-resolution spatial-element frames of the temporal segment of high-resolution spatial-element frames are not inter coded.

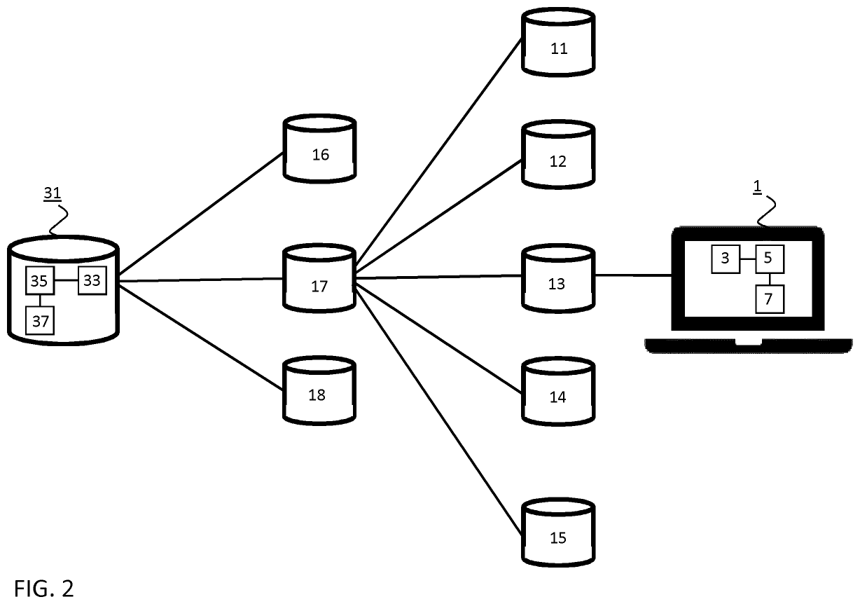

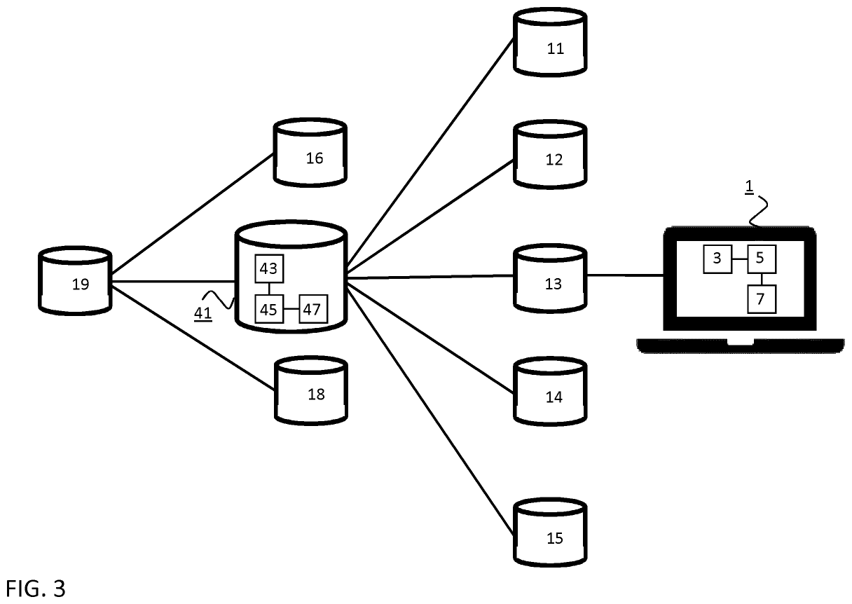

In the embodiment of FIG. 1, conventional distribution nodes are used together with the client device of the invention. Alternatively, an origin node and/or a cache node which implement the invention may be used. FIG. 2 shows the invention being implemented in the origin node 31. The origin node 31 comprise a transceiver 33, a processor 35 and a memory 37. FIG. 3 shows the invention being implemented in the (higher-level) cache node 41. The (higher-level) cache node 41 comprises a transceiver 43, a processor 45 and a memory 47.

In a first embodiment of the origin node 31 and the cache node 41, the processor 35 and the processor 45 are configured to use the transceiver 33 and the transceiver 43, respectively, to receive a request to obtain a part of a file from the requestor (the higher-level cache node 17 and the edge cache node 13, respectively). The request identifies the file and specifies a starting position. The file comprises a plurality of spatial-element frames of a spatial element of a compressed video. The compressed video comprises a plurality of spatial elements.

The processor 35 and the processor 45 are further configured to locate the file in the memory 37 and the memory 47, respectively, and obtain data from the file located in the memory 37 and 47, respectively, starting at the specified starting position. The data comprises two or more temporal segments of spatial-element frames relating to at least partly overlapping time periods. The spatial-element frames of the two or more temporal segments each comprise a plurality of video pixels. At least a first one of the two or more temporal segments of spatial-element frames comprise inter-coded spatial-element frames (e.g. P and B frames) and at least a second one of the two or more temporal segments of spatial-element frames comprising only non-inter-coded spatial-element frames (e.g. I frames). The two or more temporal segments are located near each other in the data. The processor 35 and the processor 45 are configured to use the transceiver 33 and the transceiver 43, respectively, to transmit the data to the requestor (the higher-level cache node 17 and the edge cache node 13, respectively).

In a second embodiment of the origin node 31 and the cache node 41, the processor 35 and the processor 45 are configured to use the transceiver 33 and the transceiver 43, respectively, to receive a request to start streaming spatial-element frames of a spatial element of a compressed video from a requestor, e.g. from the client device 1. The compressed video comprises a plurality of spatial elements and the request identifies the spatial element and specifies a temporal starting point

In this second embodiment, the processor 35 and the processor 45 are further configured to obtain data relating to the spatial element of the compressed video by obtaining a portion of a first temporal segment and obtaining a second temporal segment succeeding the first temporal segment. The first temporal segment comprises a certain spatial-element frame corresponding to the temporal starting point and comprises only non-inter-coded spatial-element frames (e.g. I-frames). The second temporal segment starts with a non-inter-coded spatial-element frame and comprises a plurality of inter-coded spatial-element frames (e.g. P and B frames) and the portion of the first temporal segment starts with the certain spatial-element frame. The spatial-element frames of the first and second temporal segments each comprise a plurality of video pixels. The processor 35 and the processor 45 are configured to use the transceiver 33 and the transceiver 43, respectively, to transmit the data to the requestor, e.g. to the client device 1.

In an embodiment of the client device 1, the processor 5 may be configured to display the received high-resolution spatial-element frames and pause display of the video upon receiving an instruction to pause display of the video. The processor 5 may be further configured to use the transceiver 3 to transmit one or more further requests for high-resolution spatial-element frames of a spatial element of the video for each spatial element of the video outside the user's field of view for which a client device does not possess a current high-resolution spatial-element frame upon receiving said instruction and to use the transceiver 3 to receive further high-resolution spatial-element frames in response to the further requests. The processor 5 may be further configured to display at least one of the received further high-resolution spatial-element frames upon receiving an instruction to change the user's field of view while the display of the video is being paused. The instruction to pause display of the video may be received as a result of the user pressing a button on his VR headset, for example. The instruction to change the user's field of view may be received as a result of the user moving his head while wearing his VR headset, for example.

In a variation on this embodiment, the processor 5 of the client device 1 does not specify a starting point in the one or more requests or request that the first spatial-element frame of the temporal segment of spatial-element frames is not inter coded. However, in this variation, the client device 1 may not be able to receive high-resolution spatial-element frames fast enough to achieve a low motion-to-high-res latency.

In the same or in another embodiment of the client device 1, the processor 5 is configured to use the transceiver 3 to transmit one or more further requests for low-resolution spatial-element frames of a spatial element of the video for each spatial element of the video and use the transceiver 3 to receive low-resolution spatial-element frames in response to the further requests. These low-resolution spatial-element frames may form a so-called fall-back or base layer. The processor 5 is further configured to display a current low-resolution spatial-element frame for each spatial element in the user's field of view for which the client device does not possess a current high-resolution spatial-element frame, display a current high-resolution spatial-element frame for one or more spatial elements in the user's field of view for which the client device possesses the current high-resolution spatial-element frame, and display a current low-resolution spatial-element frame for one or more further spatial elements in the user's field of view for which the client device possesses a current high-resolution spatial-element frame.

In a variation on this embodiment, the processor 5 of the client device 1 does not specify a starting point in the one or more requests or request that the first spatial-element frame of the temporal segment of spatial-element frames is not inter coded. However, in this variation, the client device 1 may not be able to receive high-resolution spatial-element frames fast enough to achieve a low motion-to-high-res latency.

The client device 1 may be a PC, laptop, mobile phone, tablet, or a VR headset, for example. The client device 1 may be connected to a VR headset, for example. In the embodiment shown in FIG. 1, the client device 1 comprises one processor 5. In an alternative embodiment, the client device 1 comprises multiple processors. The processor 5 of the client device 1 may be a general-purpose processor, e.g. an Intel or an AMD processor, or an application-specific processor, for example. The processor 5 may comprise multiple cores, for example. The processor 5 may run a Unix-based (e.g. Android), Windows or Apple operating system, for example.

In the embodiment shown in FIG. 1, a receiver and a transmitter are combined in the transceiver 3 of the client device 1. In an alternative embodiment, the client device 1 comprises a receiver and a transmitter that are separate. The transceiver 3 of the client device 1 may use, for example, one or more wireless communication technologies such as Wi-Fi, Bluetooth, GPRS, CDMA, UMTS and/or LTE and/or one more wired communication technologies such as Ethernet to communicate with other devices on the network, e.g. the edge cache node 13. There may be other devices in the path between the client device 1 and the origin node 19 that are not depicted in FIG. 1, e.g. access points, routers and switches. The memory 7 may comprise solid state memory, e.g. one or more Solid State Disks (SSDs) made out of Flash memory, or one or more hard disks, for example. The client device 1 may comprise other components typical for a client device, e.g. a power supply and/or battery and a display.

The origin node 31 may be a streaming server, for example. In the embodiment shown in FIG. 2, the origin node 31 comprises one processor 35. In an alternative embodiment, the origin node 31 comprises multiple processors. The processor 35 of the origin node 31 may be a general-purpose processor, e.g. an Intel or an AMD processor, or an application-specific processor, for example. The processor 35 may comprise multiple cores, for example. The processor 35 may run a Unix-based or Windows operating system, for example.

In the embodiment shown in FIG. 2, a receiver and a transmitter are combined in the transceiver 33 of the origin node 31. In an alternative embodiment, the origin node 31 comprises a receiver and a transmitter that are separate. The transceiver 33 of the origin node 31 may, for example, use one or more wired communication technologies such Ethernet to communicate with other devices on the Internet, e.g. the higher-layer cache nodes 16-18. The memory 37 may comprise solid state memory, e.g. one or more Solid State Disks (SSDs) made out of Flash memory, or one or more hard disks, for example. The origin node 31 may comprise other components typical for an origin node, e.g. a power supply. In the embodiment shown in FIG. 2, the origin node 31 comprises one device. In an alternative embodiment, the origin node 31 comprise multiple devices.

In the embodiment shown in FIG. 3, the higher-layer cache node 41 comprises one processor 45. In an alternative embodiment, the higher-layer cache node 41 comprises multiple processors. The processor 45 of the higher-layer cache node 41 may be a general-purpose processor, e.g. an Intel or an AMD processor, or an application-specific processor, for example. The processor 45 may comprise multiple cores, for example. The processor 45 may run a Unix-based or Windows operating system, for example.

In the embodiment shown in FIG. 3, a receiver and a transmitter are combined in the transceiver 45 of the higher-layer cache node 41. In an alternative embodiment, the higher-layer cache node 41 comprises a receiver and a transmitter that are separate. The transceiver 47 of the higher-layer cache node 41 may, for example, use one or more wired communication technologies such Ethernet to communicate with other devices on the Internet, e.g. the edge cache node 13 and the origin node 19. The memory 47 may comprise solid state memory, e.g. one or more Solid State Disks (SSDs) made out of Flash memory, or one or more hard disks, for example. The higher-layer cache node 41 may comprise other components typical for a node in a CDN network, e.g. a power supply. In the embodiment shown in FIG. 3, the higher-layer cache node 41 comprises one device. In an alternative embodiment, the higher-layer cache node 41 comprise multiple devices. The higher-layer cache node 41 may also have additional network functions, e.g. it may act as a router.

As previously described, a problem of using conventional HTTP Adaptive Streaming for delivering tiles is the way tiles are spatially and temporally segmented. If a user moves his head at Time T (during which Frame X is displayed to the user), the motion-to-high-res time of the tiled streaming system can be defined as the time it takes to display Frame Y which includes the high-resolutions versions of all the tiles of the new field of view. While there are various factors to that, such as the speed of the video decoder in the client, the depth of the framebuffer and the refresh rate of the VR headset, the most significant element that contributes to motion-to-high-res latency in tiled streaming systems is the time it takes to fetch the new tile data from the network.

The time it takes to complete any type of network request is determined by the following elements:
The round-trip-time (RTT) to the server (origin node). In other words, the number of milliseconds between sending a negligible small request to the server, and receiving the first byte of the response.
The size of the total request (in bytes)
The size of the response (in bytes)
The bandwidth of the connection between the server and the client

When this is applied to the motion-to-high-res problem, the size of the response can be more clearly defined as ‘the size of the response up until the last byte of frame Y’.

Where the RTT and bandwidth can typically be considered fixed on a given connection, and outside the realm of control of the tiled streaming application, the size of the request and the response are in control of the client, and this is exactly where current HTTP Adaptive Streaming applications fail. HTTP Adaptive Streaming segments a video stream up into temporal segments, with each segment being stored as an individual file on the network. With each segment typically having a fixed duration, the size of the network response is determined by the size of the segment. While this is not a problem if the required Frame Y is at the immediate beginning of a segment, this becomes an issue when frame Y is anywhere else in the segment. In such cases, all the bytes of all the frames before Frame Y in the segment will have to be transported before Frame Y itself is retrieved, increasing motion-to-high-res latency significantly. This especially holds when the temporal segments are long, e.g. 10 or 30 seconds (which is common in industry at the moment).

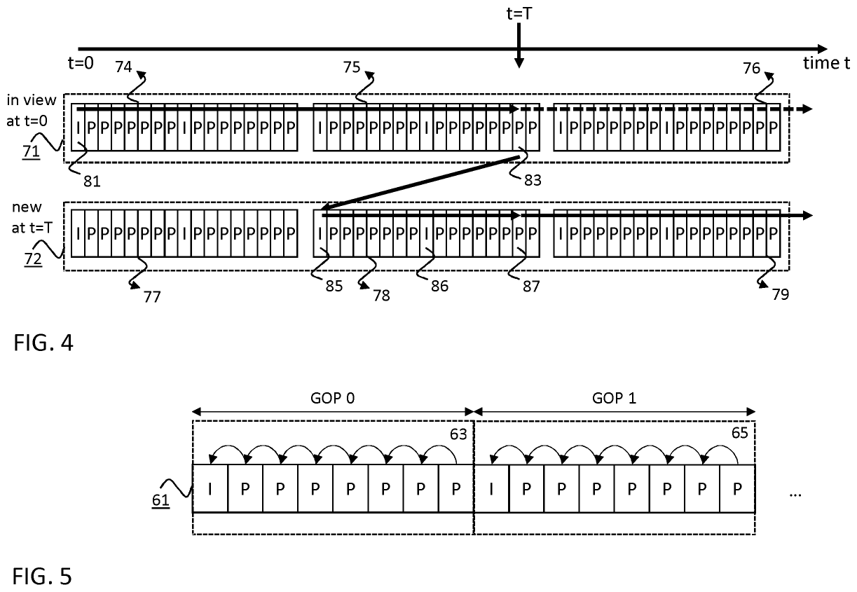

This is illustrated in FIG. 4. A spatial element 71 is in the user's field of view at time t=0. At time t=T, a first temporal segment 74 and part of a second temporal segment 75 of spatial element 71 have been fetched and displayed when a new spatial element 72 comes into the user's field of view. Now, all the spatial-element frames of temporal segment 78 of spatial element 72 have to be retrieved before frame Y, i.e. spatial-element frame 87 of temporal segment 78, itself is retrieved. Temporal segment 79 of spatial element 72 is retrieved thereafter. If spatial element 71 is still in view, despite the movement that causes spatial element 72 to come into view, temporal segment 76 of spatial element 71 is retrieved as well. Temporal segment 77 of spatial element 72 does not need to be retrieved. Each of the temporal segments 74-79 comprises two intra-coded frames (I) and 15 inter-coded frames (P).

To reduce this latency, the client device is configured to start retrieving frames at any position in the source file instead of cutting up the video into predetermined segments, only retrieving exactly those bytes that are necessary, and thereby not only reducing bandwidth requirements, but also reducing motion-to-high-res latency.

In order to allow for specific byte ranges to be requested, it may be necessary to adapt the file (container) format of the video is adapted. For example, one of the most used container formats for audio/video data is the ISO Base Media File Format (ISOBMFF) on which the MP4 specification is based. In this format, audio/video data is placed into ISOBMFF Boxes (or Atoms). While there exist a huge variety of boxes to describe all kinds of metadata and related information, and a typical ISOBMFF file will contain hundreds of these, the actual audio/video payload data is typically placed in ‘mdat’ boxes. In general, at least one GOP length of frames, but typically more, and even up to the full length of the content, is stored in a single ‘mdat’ box. As a result, if the client device can retrieve a single frame, this will not correspond to a full ISOBMFF box. The client device may therefore need to reconstruct a new ISOBMFF box around the retrieved data on the client side in order for it to be able to present the data to the decoder. An alternative solution would be to place each frame in its own ISOBMFF box during the packaging process, although this would mean the amount of ISOBMFF overhead will increase (given that each ISOBMFF box includes headers).

While the method described above allows a client device to have random access to any frame of every spatial element from a network point of view, the specifics of video or audio codec-specific constraints mean that the client device will not necessarily be able to decode all of those frames.

In a very simplified way, the way video compression typically works is by periodically encoding a reference frame, a so-called intra-coded picture (or I-frame), and for each subsequent frame only encoding the difference between that frame, the reference frame and any other frames up until one or more reference frames, which may be in the past or the future with respect to the frame that is required. This is shown in FIG. 5. A video 61 comprises a plurality of Groups of Pictures (GOPs), including a Group of Pictures 63 and a Group of Pictures 65. Each Group of Pictures comprises one intra-coded picture and multiple inter-coded pictures. To decode such inter-encoded pictures (which can be P-frames or B-frames), the decoder requires access to the preceding or first-next I-frame, as well as one or more B-frames and/or P-frames.

For tiled streaming, this means that in order to decode frame Y, i.e. spatial element 87 of FIG. 4, the decoder might need to have access to frames Y-1, Y-2 and Y-N (the intra-coded frame 86 of FIG. 4 and the inter-coded frames between intra-coded frame 86 and frame Y) as well. Even if the number of frames on which frame Y depends is bounded by the so-called GOP-size (for Group of Pictures-size, the size of the group of all frames that depend on each other), each additional frame increases the size of the network request, and thereby the motion-to-high-res latency.

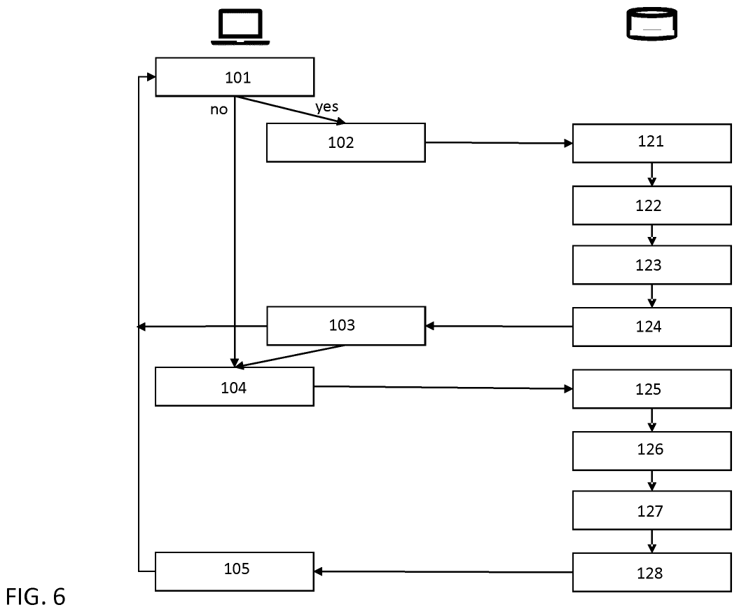

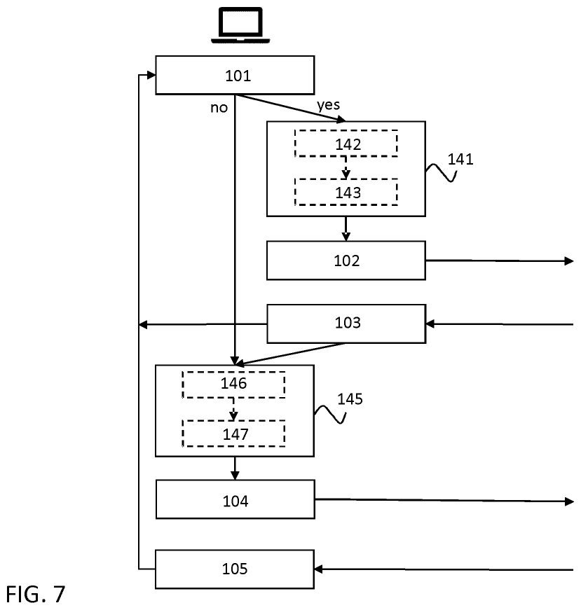

This latency can be reduced by encoding each spatial element at least twice: a main stream with a sufficiently large GOP size to increase maximum compression efficiency, and one I-frame-only stream (also known as intra-only) with a GOP size of 1, which means there are only I-frames and no P-frames, and thus no dependencies between frames. When a new spatial element comes into the user's field of view at a moment that doesn't immediately precede an I-frame, the client device may retrieve the I-frame-only stream up until the moment an I-frame is scheduled to arrive in the main stream, at which point it switches to the main stream (which may be a different representation of the spatial element). This way, the client device is able to start playback from any frame of every spatial element, at the cost of briefly having a somewhat higher bitrate (because the compression efficiency of the I-only stream will be lower). Thus, the method of transmitting a request for video data of the invention involves the client device requesting a non-inter-coded high-resolution spatial-element frame that it can display promptly, e.g. within 100 ms, for each spatial element of a video in a user's field of view for which a client device does not possess a current high-resolution spatial-element frame. This is described in more detail in relation to FIGS. 6 and 7.

A first embodiment of methods of the invention are shown in FIG. 6. A step 101 comprises the client device detecting whether the user's field of view has changed. If the user's field of view has not changed, step 104 is performed next. If the user's field of view has changed, step 102 is performed. Step 102 comprises the client device transmitting one or more requests for high-resolution spatial-element frames of the spatial element of the video to a distribution node for each spatial element of a video in a user's field of view for which a client device does not possess a current high-resolution spatial-element frame. The video comprises a plurality of spatial elements and a plurality of spatial-element frames for each of the plurality of spatial elements. The plurality of spatial-element frames comprises both non-inter-coded spatial-element frames and inter-coded spatial-element frames. The one or more requests identifies the spatial element and specifies a starting point corresponding substantially to a current time and the one or more requests being for data comprising a temporal segment of high-resolution spatial-element frames starting substantially at the starting point. The first high-resolution spatial-element frame of the temporal segment of high-resolution spatial-element frames is not inter coded. The spatial-element frames may be HEVC tiles, for example.

A step 121 comprises the distribution node receiving the one or more requests. The distribution node may be a cache node or origin node, for example. The starting point may be specified in the request as a point in time, a temporal index value or a position in a file. A step 122 comprises the distribution node locating the requested spatial-element frames of the video in a memory. A step 123 comprises the distribution node obtaining the requested spatial-element frames from the memory. A step 124 comprises transmitting the obtained spatial-element frames to the client device. If the distribution node is not able to locate the requested spatial-element frames in the memory, the distribution node may attempt to obtain the requested spatial-element frames from another distribution node, e.g. if the distribution node is a cache node. This is not depicted in FIG. 6. This other distribution node may perform the same steps 121-124, but the distribution node will typically request more spatial-element frames from the other distribution node than are requested from it by the client device.

Step 103 comprises the client device receiving the transmitted data from the distribution node in response to the one or more requests for each of the spatial elements for which the one or more requests is transmitted. The data comprises a temporal segment of high-resolution spatial-element frames starting substantially at the starting point. The high-resolution spatial-element frames of the temporal segment each comprise a plurality of video pixels. The first one or more high-resolution spatial-element frames of the temporal segment of spatial-element frames are not inter coded and the first high-resolution spatial-element frame will be obtained from the aforementioned I-frame-only stream in most cases. The temporal segment may further comprise inter-coded frames (e.g. P-frames and B-frames) from the afore-mentioned main stream. The non-inter-coded frame directly preceding the first inter-coded frame will typically be obtained from the main stream as well.

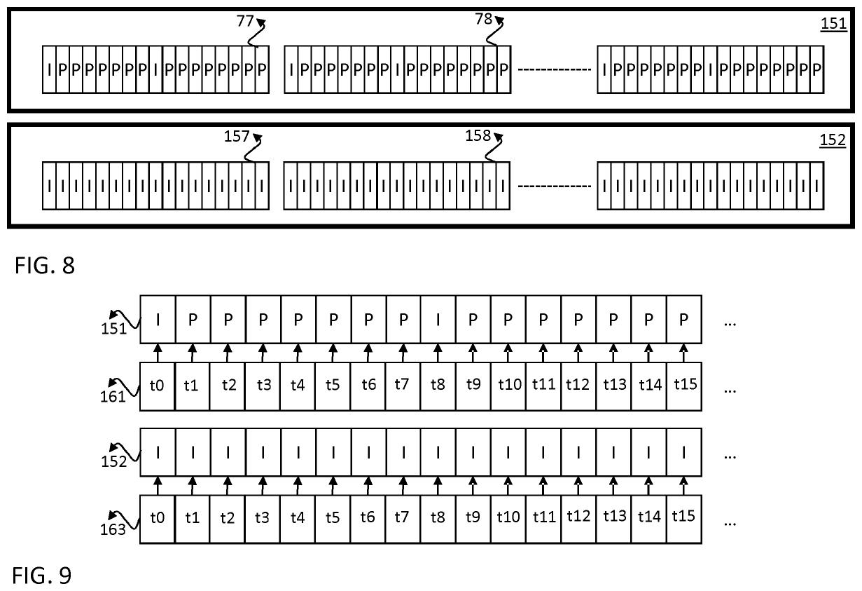

FIG. 8 shows an example of a packaging of the I-only stream 152 and main stream 151 in two separate containers of a certain temporal length. Headers are not included in FIG. 8 for clarity. Main stream 151 comprises the temporal segments 77 and 78 of FIG. 4 and further temporal segments. I-only stream 152 comprises temporal segments 157 and 158 and further temporal segments.

Often, the current view and the previous view will have at least a few spatial elements in common. If so, step 104 is performed next. If not, step 101 is performed again. Step 104 comprises the client device transmitting one or more further requests for spatial-element frames of the spatial element of the video to the distribution node for spatial elements of a video in a user's field of view for which a client device already possesses a current spatial-element frame (because it received them in the current iteration or in a previous iteration of step 103 or in a previous iteration of step 105). These spatial-element frames are therefore less urgent. The one or more further requests identify the spatial element and specify a further starting point corresponding substantially to a current time.

A step 125 comprises the distribution node receiving the one or more further requests. A step 126 comprises the distribution node locating the requested spatial-element frames of the video in a memory. A step 127 comprises the distribution node obtaining the requested spatial-element frames from the memory. A step 128 comprises transmitting the obtained spatial-element frames to the client device. If the distribution node is not able to locate the requested spatial-element frames in the memory, the distribution node may attempt to obtain the requested spatial-element frames from another distribution node, e.g. if the distribution node is a cache node. This is not depicted in FIG. 6. This other distribution node may perform the same steps 125-128, but the distribution node will typically request more spatial-element frames from the other distribution node than are requested from it by the client device.

Step 105 comprises the client device receiving the transmitted data from the distribution node in response to the one or more further requests. The received spatial-element frames have been obtained from the main stream. After step 105, step 101 is performed again. The received data may be decoded and rendered in a further step between step 105 and step 101 (not shown) or by a method performed in parallel, for example.

It may be beneficial to modify the bitstream before passing it to de decoder to make the bitstream valid (again). Most codecs, e.g. HEVC, have some form of positioning information in each NAL header that allows the decoder to know where the particular slice belongs in a larger frame. This positioning information (in HEVC signaled in the ‘slice_segment_address’ field), is usually indicated by counting the number of coding tree blocks (or macroblocks) in raster scan order. In viewport-adaptive streaming however, when only a subset of a total panorama is streamed at any given time, the location of a spatial-element frame when presented to the decoder might not match its position in the original bitstream. For example, a spatial element that used to be in the top-left corner of the source panorama, might at some point be in the bottom-right corner of a user's field of view. In addition, a spatial-element that might be in the middle of a viewport at one moment might be at the top of the viewport a few frames later.

Because of this, it is inefficient and often impossible to have a strict relationship between the location of a spatial-element frame in the source panorama, its location in the decoded bitstream and its location in the renderer viewport. Downloaded spatial-element frames may therefore be arbitrarily assigned to positions in the decoded bitstream and the slice_segment_address in the slice header of each spatial-element frame should then be rewritten by the client before the NAL unit is presented to the decoder. When decoding is complete, and a new frame is outputted, the rendering step can make sure that the spatial-element frames are reshuffled to their intended position in the rendered viewport.

In a first embodiment of the method of transmitting the request, the starting point is specified as a position in a file. This embodiment is shown in FIG. 7. A step 141 is performed before step 102. Step 141 comprises determining the starting point by looking up a position in a file by using an index associated with the file. The position corresponds substantially to a current time and the index comprises a mapping from a point in time or a temporal index value to a position in the file.

For example, the spatial-element frames may be stored in a (containerized) format on a server along with an index file that allows accurate retrieval of only those data bytes belonging to a certain video frame. An embodiment of this mechanism is an index containing the byte ranges of all the frames in a certain file. After retrieving the index, the client can use HTTP Byte Range Requests for full random access to each frame (including but not limited to audio, video, subtitles and other sorts of metadata) stored on the server.

If the I-only and main streams are packaged in two separate containers, as shown in FIG. 8, preferably two indices are used and step 141 comprises a sub step 142 of selecting one index from the plurality of indices associated with the two files. The two indices each comprise a mapping from a point in time or a temporal index value to a position in the two files. Step 141 then further comprises a sub step 143 of looking up the position in the two files by using the selected index. The position corresponds to a position of a non-inter-coded spatial-element frame in the one or more files. A step 145 is performed before step 104. Step 145 comprises determining the further starting point (to be specified in the one or more further requests transmitted in step 104) by looking up a position in a file in a sub step 147 by using another one of the plurality of indices, selected in a sub step 146.

The main stream 151 and the I-only stream 152 of FIG. 8 are shown in FIG. 9 along with the associated indices. Index 161 is associated with main stream 151. Index 163 is associated with I-only stream 152. The indices comprise index data describing the byte offsets for each of the spatial-element frames of the streams. The point in time (t0, . . . t15, . . . tn) may be an elapsed time or elapsed frame count since the start of the video, for example.

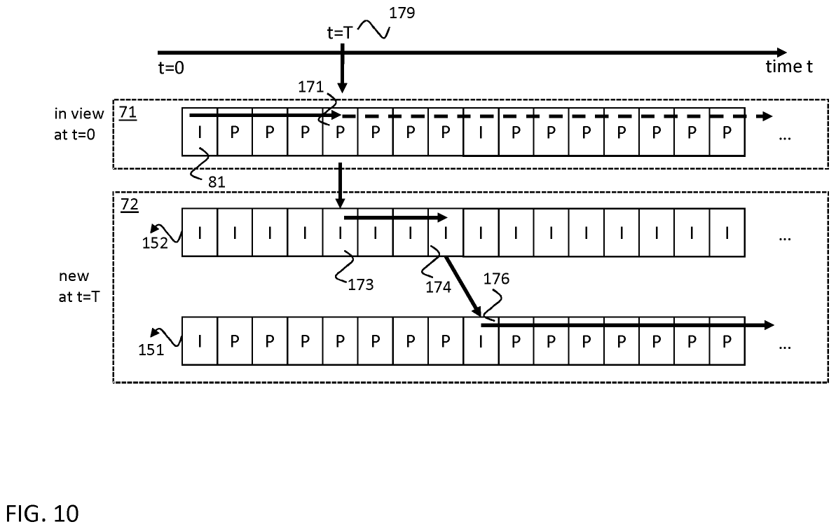

FIG. 10 shows a spatial-element frame 171 of the spatial element 71 of FIG. 4 being decoded when at time t=T, i.e. time 179, a spatial element 72 comes into view. First, I-frame 173, I-frame 174 and the I-frames between I-frame 173 and I-frame 174 of the intra-encoded stream 152 of spatial element 72 are decoded before switching to the main (IPP encoded) stream 151 of spatial element 72 and decoding I-frame 176. If spatial element 71 is still in view, despite the movement that causes spatial element 72 to come into view, the spatial-element frames after spatial-element frame 171 are retrieved as well.

Since a frame is typically obsolete after 40 ms (25 fps) or 33.33 ms (30 fps), upscaled versions of low-resolution spatial-element frames from a fallback layer may be displayed if the requested one or more high-resolution spatial-element frames are not received before the next spatial-element frame needs to be displayed. The client device may be able to calculate an average round-trip-time and if this average round-trip-time is more than a frame duration (e.g. more than 40 ms), not request a temporal segment starting with the current high-resolution spatial-element frame, but with the high-resolution spatial-element frame after the current high-resolution spatial-element frame. Which high-resolution spatial-element frame is requested as first frame may be determined based on the average round-trip-time, for example.

Variations of this mechanism can exist in which not two streams are used (I and IPP) per spatial element but many IPP streams per spatial element, staggered in time, and only one I-only stream per spatial element. Such variations could be used to reduce the time spent in the I-only stream by switching to the first IPP stream of which an I-frame can be displayed. This will reduce bandwidth spikes due to I-frame only streaming but requires more storage on the network and more encoding resources to create the content. Other ways to reduce the I-frame spike could be to stream reference frames (I-frames) at a fraction (e.g. half) of the framerate of the original stream and locally interpolate them in the temporal domain to match the original framerate. This will reduce the network stress but will also reduce the end user experience.

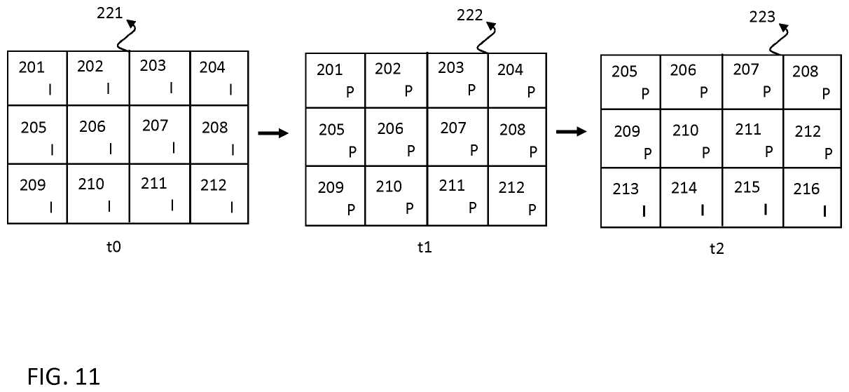

What happens when a user's field of view changes is further illustrated with the help of FIG. 11. An initial view 221 is shown to the user at time t=t0. A view 222 is shown to the user at time t=t1. A view 223 is shown to the user at time t=t2. I-frames of spatial elements 201-212 are decoded in order to show initial view 221. Since view 222 has the same spatial elements 201-212 as initial view 221, P-frames of the spatial elements 201-212 can be fetched and decoded, as the client device possesses the necessary I-frames. The user changes his (field of) view between time t1 and time t2 by looking down. As a result, new spatial elements 213-216 come into view, i.e. are present in view 223. To ensure that high-res frames can be displayed fast enough, I-frames are fetched and decoded for these spatial elements 213-216. For the existing spatial elements 205-212, P-frames can be fetched and decoded, as the client device possesses the necessary I-frames.

In a second embodiment of the method of transmitting the request, the starting point is specified as a point in time or a temporal index instead of as a position in a file. In this second embodiment, the client device does not need to use one or more indices, because the distribution node is more intelligent. In an embodiment of the method of transmitting the video data, step 123 of FIG. 6 comprises obtaining data relating to the spatial element of the compressed video by obtaining a portion of a first temporal segment (from the I-only stream) and obtaining a second temporal segment (from the main stream) succeeding the first temporal segment. The first temporal segment comprises a certain spatial-element frame corresponding to the temporal starting point and the first temporal segment comprises only non-inter-coded spatial-element frames. The second temporal segment comprises a plurality of inter-coded spatial-element frames and the portion of the first temporal segment starts with the certain spatial-element frame. The spatial-element frames of the first and second temporal segments each comprise a plurality of video pixels.

As previously described, FIG. 8 shows each video stream being packaged in two different containers of a certain temporal length. By instead packaging the main stream (containing both I-frames and P-frames) and the I only-stream in the same package, with a certain interleaving, both the frequency with which the main stream is accessed and the afore-mentioned CDN-internal chunking behavior can be exploited to increase the chances of the I-only-stream being cached in the CDN edge cache. In other words, the container comprises two or more temporal segments of spatial-element frames relating to at least partly overlapping time periods for a plurality of time periods, at least a first one of the two or more temporal segments of spatial-element frames comprises inter-coded spatial-element frames and at least a second one of the two or more temporal segments of spatial-element frames comprises only non-inter-coded spatial-element frames. The two or more temporal segments are stored near each other in the file, thereby resulting in the certain interleaving.

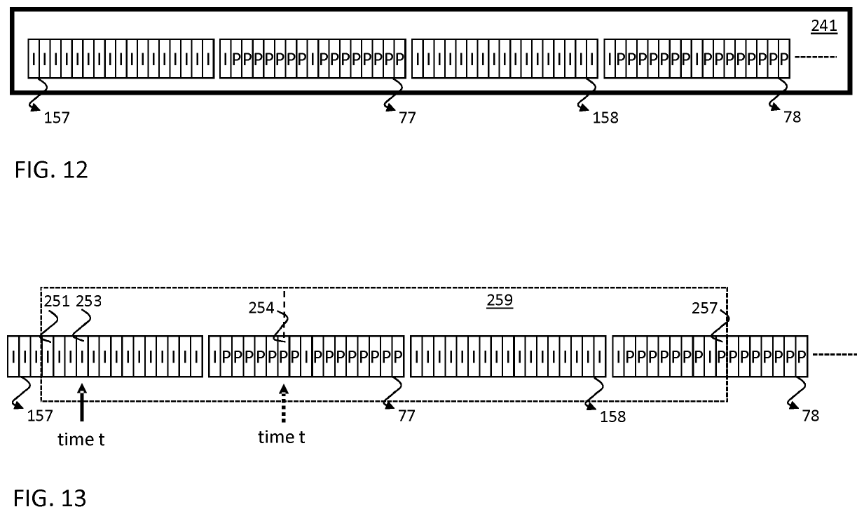

An example of such packaging is shown in FIG. 12. FIG. 12 shows an enhanced packaging of the I-only and main (IPP) streams in a single container 241 of a certain temporal length. Temporal segments 157 and 158 are part of the I-only stream and temporal segments 77 and 78 are part of the main stream. Headers are not included in FIG. 12 for clarity. Other options exist to structure this interleaved stream in a container while still exploiting the afore-mentioned CDN chunking behavior. This form of packaging not only improves the chances of the I-only-stream being cached, it also makes sure that whenever the I-only-stream is cached, the frames of the IPP stream that directly follow it will be cached as well, which is especially useful in cases where the client jumps in at one of the last frames of the GOP.

A third advantage of this form of packaging is the way in which it reduces the total number of independent HTTP Requests that have to be carried out. Normally, with the main stream and I-only stream being packaged independently, this would result in at least two separate HTTP requests. With the improved packaging, this is reduced to one single request. This not only reduces overhead and network traffic, it is also beneficial for prioritization purposes. If the client device sends both requests at the same time (not knowing whether either is cached or not), the frames being returned from the main stream will compete for bandwidth with the streams being requested from the I-only-stream, despite the latter frames being required earlier. In the new situation, since they are part of the same request, they will be returned sequentially and in-order, thereby further reducing the chances of a high motion-to-high-res latency.

FIG. 13 shows a chunk 259 retrieved by a cache node. The chunk 259 comprises the temporal segments 77 and 158 and part of the temporal segments 157 and 78 of FIG. 12 and thus a combination of I and IPP frames. The chunk 259 is retrieved by the cache node when the client device transmits a request specifying the position of P-frame 254 at time t as starting position and the cache node does not have the requested spatial-element frames in its (cache) memory. The chunk 259 comprises a part before the P-frame 254, starting with I-frame 251, and a part after the P-frame 254, ending with P-frame 257. The chunk 259 not only comprises the requested P-frame 254 at time t, but also the corresponding I-frame 253 at time t. Since frames from the main stream are requested more often than frames from the I-only stream, this results in a larger probability that frames from the I-only stream will be cache at the edge cache node. Headers are not included in FIG. 13 for the sake of clarity.

This packaging can be applied to different file formats. For example, it may be implemented in a generic ISOBMFF container or in an MP4 container. In this case, the ISOBMFF/MP4 packager may be instructed that it should use a specific interleaving mechanism, and the different ISOBMFF boxes/atoms may be interleaved accordingly. As another example, an MPEG2-TS container may be used and the different streams may be multiplexed according to the chosen interleaving mechanism.

This packaging can be used in a further embodiment of the method of transmitting the video data. In this further embodiment, the data obtained in steps 123 and 127 of FIG. 6 and transmitted in a signal in steps 124 and 128 (and/or in the equivalent steps performed by another distribution node, as described in relation to FIG. 6) comprises two or more temporal segments of spatial-element frames relating to at least partly overlapping time periods. The spatial-element frames of the two or more temporal segments each comprise a plurality of video pixels. At least a first one of the two or more temporal segments of spatial-element frames comprises inter-coded spatial-element frames and at least a second one of the two or more temporal segments of spatial-element frames comprises only non-inter-coded spatial-element frames. The two or more temporal segments are located near each other in the data. The packaging of FIG. 12 meets these requirements. If the request further specifies an ending position, step 123 comprises obtaining the data from the specified starting position until the specified ending position. This method may be performed by an edge cache node, higher-level cache node or origin node, for example.

As shown in FIG. 12, the two or more temporal segments of spatial-element frames may substantially correspond to the same uncompressed video data, the two or more temporal segments of spatial-element frames may be stored sequentially in the file and the first one of the two or more temporal segments of spatial-element frames comprises, for example, at most one or two non-inter-coded spatial-element frames.

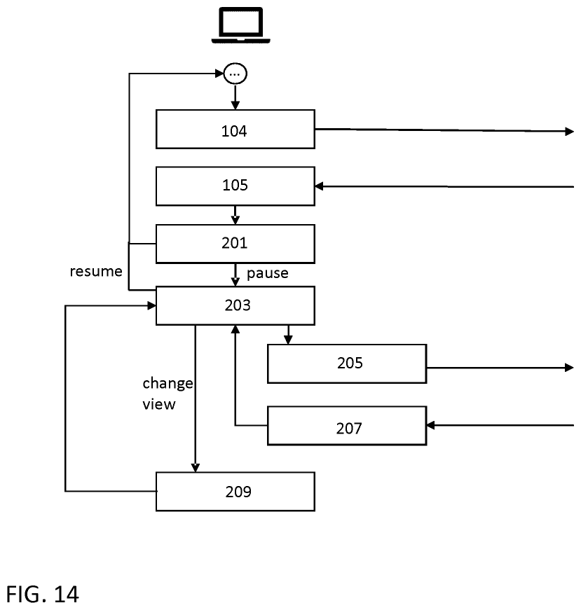

The embodiments of the methods shown in FIGS. 6-7 may be extended with the steps shown in FIG. 14. With traditional video, pausing and resuming playback is as simple as temporarily halting the decoder and rendering process. After the user wants to resume playback, the decoder and renderer can simply resume from where they left off. If the same techniques are applied to viewport-adaptive streaming solutions such as the one described above, where only a part of the total video is retrieved and decoded at any point in time, this will result in the user only being able to see a small area of the total spherical video in high resolution while he is paused, i.e. the area which was in the viewport at the moment pause was selected. The rest of the video was not decoded and therefore cannot be viewed. This gives a very poor quality of experience.

What is needed to solve this problem is to provide a way to allow the user to look around the spherical video while paused that always shows the current viewport in the maximum possible quality/resolution. This is realized with steps 201-209.

After step 105, a step 201 is performed. Step 201 comprises displaying the high-resolution spatial-element frames received in steps 103 and 105. Step 203 comprises pausing display of the video upon receiving an instruction to pause display of the video. This causes steps 205 and 207 to be performed. Step 205 comprises the client device transmitting one or more further requests for high-resolution spatial-element frames of a spatial element for each spatial element of the video outside the user's field of view for which a client device does not possess a current high-resolution spatial-element frame. Step 207 comprises the client device receiving further high-resolution spatial-element frames in response to the further requests.

Step 209 comprises displaying one or more of the received further high-resolution spatial-element frames upon receiving an instruction to change the user's field of view while the display of the video is being paused. In this embodiment, step 209 comprises rewriting metadata in a bitstream comprising the one or more of the received further high-resolution spatial-element frames, and (upscaled) low-resultion spatial-element frames if applicable, to make the bitstream valid. In particular, in this embodiment, step 209 comprises rewriting an index number, e.g. a Picture Order Count (POC) value, of the one or more of the received further high-resolution spatial-element frames in the metadata before passing the bitstream to a decoder. In this embodiment, step 209 further comprises rewriting the slice header of each spatial-element frame, as previously described.

In other words, in contrast to traditional video players, the decoded and rendered frame that is displayed to the end-user will need to be constantly updated while playback is paused. Given that a (hardware) decoder will typically not be able to decode the entire spherical video, this means that the decoder will need to be kept running while the video is paused, so that whenever the user moves his head, new spatial-element frames can be fed to the decoder that will then be decoded and rendered onto the sphere. This typically means that new spatial-element frames need to be retrieved from the network.

Furthermore, due to the way standardized codecs such as AVC and HEVC work, the same spatial-element frames (or spatial-element frames belonging to the same overall video frame) cannot simply be repeatedly fed to the decoder. In the header of each encoded frame of a video (and thus each spatial-element frame) is an index value, called a Picture Order Count (or POC) in some codecs, that is incremented for each sequential frame. This POC is used by the decoder to keep track of frame numbering and to reference individual frames in the bitstream whenever inter-frame prediction is used. If the same frame would be fed to the decoder two times in a row, the POC of successive frames would be the same and the bitstream fed to the decoder would be invalid, causing the decoder to reject the bitstream or even crash.

It is therefore beneficial to rewrite the POC field of individual spatial-element frames before feeding them into the decoder when the video is paused, causing the decoder to interpret the repeated frames as new frames and keeping the decoder running. Whenever playback is resumed, the POC rewriting process might need to continue in order to make sure there are no discontinuities in the POC numbering.

While the above solves the issue of keeping the decoder running, it is not always sufficient for making sure that a valid bitstream is presented to the decoder while paused. Depending on the specific codec used, rewriting the POC might not result in a valid bitstream if the frame that is repeated is not an I-frame. This is because the inter-frame references in a P-frame might be thrown off if the relative position of the frame in the GOP is changed by repeating a particular frame (causing the distance in frames to the previous I-frame to change). In such cases, it is necessary to either skip or wait to the next I-frame in the video, to go back to the previous I-frame, and then use that particular I-frame to repeatedly feed to the decoder or to retrieve an I-frame from an I-only stream as previously described (while applying the POC rewriting mechanism described above).

Alternatively, the steps shown in FIG. 14 may be used to enhance conventional viewport-adaptive streaming methods.

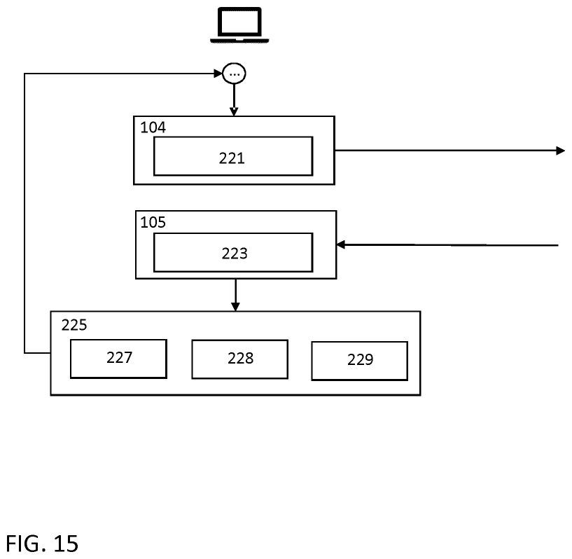

The embodiments of the methods shown in FIGS. 6-7 may be extended with the steps shown in FIG. 15. The client device may experience a brief network interruption or slow down while retrieving spatial-element frames, causing the system to not have data (e.g. HEVC NAL data) available for a given spatial element when it is time to present the next frame to the decoder. In such a case, the system might decide to accept this data loss and proceed with the next frame instead of waiting for the data to arrive (which would cause an interruption in the playback). This will not only cause a problem when the current, missed spatial-element frame needs to be displayed, but possibly for quite a few spatial-element frames to come, given that future spatial-elements frames might have dependencies on the missed spatial-element frame (irrespective of whether the missed frame was a P or I frame) and cause these spatial-element frames to be ‘damaged’ after being decoded. The visual artefacts that result from this will degrade the quality of experience of the user. Especially if the missed spatial-element frame was an I-frame, the visual degradation might be quite severe. Steps 221-229 of FIG. 15 are intended to help to reduce this visual degradation.

Step 104 of FIGS. 6-7 comprises a step 222 and step 105 of FIGS. 6-7 comprises a step 223. Step 221 comprises the client device transmitting one or more further requests for low-resolution spatial-element frames of the spatial element of the video for each spatial element of the video, e.g. a fallback layer. Step 223 comprises receiving low-resolution spatial-element frames in response to the further requests.

Step 225 is performed after step 105. Step 225 comprises displaying the current spatial-element frames and comprises sub steps 227, 228 and 229. Step 227 comprises displaying (an upscaled version of) a current low-resolution spatial-element frame for each spatial element in the user's field of view for which the client device does not possess a current high-resolution spatial-element frame. Step 228 comprises displaying a current high-resolution spatial-element frame for one or more spatial elements in the user's field of view for which the client device possesses the current high-resolution spatial-element frame. Step 229 comprises displaying (an upscaled version of) a current low-resolution spatial-element frame for one or more further spatial elements in the user's field of view for which the client device possesses a current high-resolution spatial-element frame.

In other words, the client device may decide to continue with decoding but replace a ‘damaged’ spatial-element frame with an upscaled spatial-element frame of the fallback layer to replace it during rendering. While the quality of the upscaled fallback spatial-element frame will be worse than the high-resolution spatial-element frames, it will often still be better than showing a ‘damaged’ spatial-element frame.

In the embodiment shown in FIG. 15, a current low-resolution spatial-element frame is displayed in step 229 for a further spatial element if the current high-resolution spatial-element frame is inter-coded and the client device does not possess a previous non-inter-coded high-resolution spatial-element frame on which the current high-resolution spatial-element frame depends. In an alternative embodiment, a current low-resolution spatial-element frame is displayed in step 229 for a further spatial element if decoding the current high-resolution spatial-element frame is assessed to result in a lower quality decoded frame than decoding the current low-resolution spatial-element frame.

In the embodiment shown in FIG. 15, a current high-resolution spatial-element frame is displayed in step 228 for a further spatial element if the current high-resolution spatial-element frame is inter-coded, the client device possesses a previous non-inter-coded high-resolution spatial-element frame on which the current high-resolution spatial-element frame depends and the client device does not possess one or multiple inter-coded high-resolution spatial-element frames on which the current high-resolution spatial-element frame depends. In an alternative embodiment, a current low-resolution spatial-element frame is displayed instead of the current high-resolution spatial-element frame in this case.

Alternatively, the steps shown in FIG. 15 may be used to enhance conventional streaming methods.

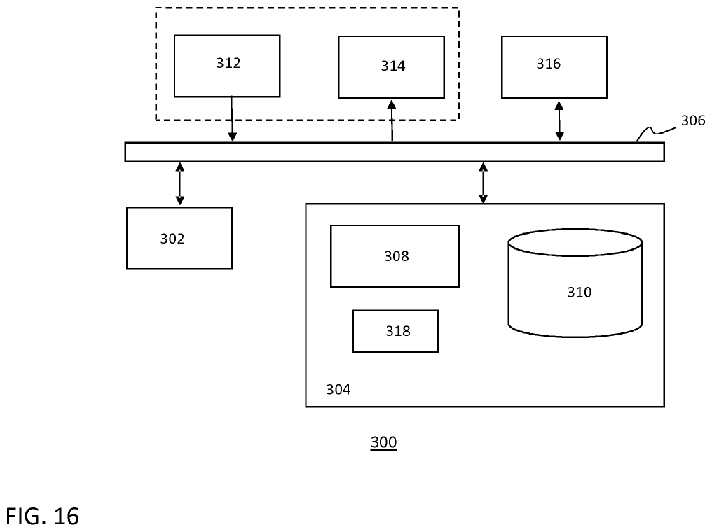

FIG. 16 depicts a block diagram illustrating an exemplary data processing system that may perform the methods as described with reference to FIGS. 6-7 and FIGS. 14-15.

As shown in FIG. 16, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 16 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 16, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 14) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of transmitting a request for video data, comprising:
for each spatial element of a video in a user's field of view for which a client device does not possess a current high-resolution spatial-element frame, said client device transmitting one or more requests for high-resolution spatial-element frames of said spatial element of said video to a distribution node, said video comprising a plurality of spatial elements and a plurality of spatial-element frames for each of said plurality of spatial elements, said plurality of spatial-element frames comprising both non-inter-coded spatial-element frames and inter-coded spatial-element frames, only said inter-coded spatial-element frames being encoded with reference to one or more other spatial-element frames of said plurality of spatial-element frames, said one or more requests identifying said spatial element; and
for each of said spatial elements for which said one or more requests is transmitted, said client device receiving data relating to said spatial element of said video from said distribution node in response to said one or more requests, said data comprising a temporal segment of high-resolution spatial-element frames, said high-resolution spatial-element frames of said temporal segment each comprising a plurality of video pixels,
wherein said one or more requests specify a starting point corresponding to a current time, said one or more requests are for data comprising a temporal segment of high-resolution spatial-element frames starting at said starting point of which the first high-resolution spatial-element frame is not inter coded, and said temporal segment of high-resolution spatial-element frames received by said client device starts at said starting point, the first one or more high-resolution spatial-element frames of said temporal segment of high-resolution spatial-element frames not being inter coded.

2. The method as claimed in claim 1, wherein said starting point is specified as a position in a file and said file comprises two or more temporal segments of high-resolution spatial-element frames relating to at least partly overlapping time periods for a plurality of time periods, at least a first one of said two or more temporal segments of high-resolution spatial-element frames comprising inter-coded spatial-element frames and at least a second one of said two or more temporal segments of spatial-element frames comprising only non-inter-coded spatial-element frames, said two or more temporal segments being stored near each other in said file.

3. The method as claimed in claim 2, further comprising determining said starting point by looking up a position in a file by using an index associated with said file, said position corresponding substantially to a current time and said index comprising a mapping from a point in time or a temporal index value to a position in said file.

4. The method as claimed in claim 3, wherein determining said starting point comprises selecting one index from a plurality of indices associated with one or more files, said one or more files including said file, said plurality of indices each comprising a mapping from a point in time or a temporal index value to a position in said one or more files, and looking up said position in said one or more files by using said selected index, said position corresponding to a position of a non-inter-coded spatial-element frame in said one or more files.

5. The method as claimed in claim 4, further comprising, for at least one of said spatial elements for which said one or more request is transmitted, said client device transmitting one or more further requests for further high-resolution spatial-element frames of said spatial element of said video to said distribution node, said one or more further requests identifying said spatial element and specifying a further starting point corresponding substantially to a current time, and determining said further starting point by looking up a position in a file by using another one of said plurality of indices.

6. The method as claimed in claim 1, further comprising:
displaying said received high-resolution spatial-element frames;
pausing display of said video upon receiving an instruction to pause display of said video;
upon receiving said instruction, for each spatial element of said video outside said user's field of view for which a client device does not possess a current high-resolution spatial-element frame, said client device transmitting one or more further requests for high-resolution spatial-element frames of said spatial element;
receiving further high-resolution spatial-element frames in response to said further requests; and
displaying at least one of said received further high-resolution spatial-element frames upon receiving an instruction to change said user's field of view while said display of said video is being paused.

7. The method as claimed in claim 1, further comprising:
for each spatial element of said video, said client device transmitting one or more further requests for low-resolution spatial-element frames of said spatial element of said video;
receiving low-resolution spatial-element frames in response to said further requests;
displaying a current low-resolution spatial-element frame for each spatial element in said user's field of view for which said client device does not possess a current high-resolution spatial-element frame;
displaying a current high-resolution spatial-element frame for one or more spatial elements in said user's field of view for which said client device possesses said current high-resolution spatial-element frame; and
displaying a current low-resolution spatial-element frame for one or more further spatial elements in said user's field of view for which said client device possesses a current high-resolution spatial-element frame.

8. A method of transmitting video data, comprising:
receiving a request to obtain a part of a file from a requestor, said request identifying said file, said file comprising a plurality of spatial-element frames of a spatial element of a compressed video, said compressed video comprising a plurality of spatial elements;
locating said file in a memory;
obtaining data from said file located in said memory and
transmitting said data to said requestor,
wherein said request specifies a starting position, said data is obtained starting at said specified starting position, and said data comprises two or more temporal segments of spatial-element frames relating to at least partly overlapping time periods, said spatial-element frames of said two or more temporal segments each comprising a plurality of video pixels, at least a first one of said two or more temporal segments of spatial-element frames comprising inter-coded spatial-element frames and at least a second one of said two or more temporal segments of spatial-element frames comprising only non-inter-coded spatial-element frames, only said inter-coded spatial-element frames being encoded with reference to one or more other spatial-element frames of said plurality of spatial-element frames and said two or more temporal segments being located near each other in said data.

9. The method as claimed in claim 8, wherein said request further specifies an ending position and said data is obtained from said specified starting position until said specified ending position.

10. The method as claimed in claim 9, wherein said two or more temporal segments of spatial-element frames are stored sequentially in said file.

11. The method as claimed in claim 8, wherein said request specifies a further starting position and further comprising:
obtaining further data from said file located in said memory starting at said specified further starting position, said further data comprising two or more further temporal segments of spatial-element frames relating to at least partly overlapping time periods, said spatial-element frames of said two or more further temporal segments each comprising a plurality of video pixels, at least a first one of said two or more further temporal segments of spatial-element frames comprising inter-coded spatial-element frames and at least a second one of said two or more further temporal segments of spatial-element frames comprising only non-inter-coded spatial-element frames; and
transmitting said further data to said requestor.

12-13. (canceled)

14. A client device, comprising:
at least one transmitter;
at least one receiver; and
at least one processor configured to:
for each spatial element of a video in a user's field of view for which said client device does not possess a current high-resolution spatial-element frame, use said at least one transmitter to transmit one or more requests for high-resolution spatial-element frames of said spatial element of said video to a distribution node, said video comprising a plurality of spatial elements and a plurality of spatial-element frames for each of said plurality of spatial elements, said plurality of spatial-element frames comprising both non-inter-coded spatial-element frames and inter-coded spatial-element frames, only said inter-coded spatial-element frames being encoded with reference to one or more other spatial-element frames of said plurality of spatial-element frames, said one or more requests identifying said spatial element, and
for each of said spatial elements for which said one or more requests is transmitted, use said at least one receiver to receive data relating to said spatial element of said video from said distribution node in response to said one or more requests, said data comprising a temporal segment of high-resolution spatial-element frames,
wherein said one or more requests specify a starting point corresponding to a current time, said one or more requests are for data comprising a temporal segment of high-resolution spatial-element frames starting at said starting point of which the first high-resolution spatial-element frame is not inter coded, and said received temporal segment of high-resolution spatial-element frames starts at said starting point, the first one or more high-resolution spatial-element frames of said temporal segment of high-resolution spatial-element frames not being inter coded, and
said at least one processor is configured to determine said starting point before transmitting said one or more requests by looking up a position in a file by using an index associated with said file, said position corresponding to a current time and said index comprising a mapping from a point in time or a temporal index value to a position in said file.

15. A distribution node, comprising:
at least one receiver;
at least one transmitter; and
at least one processor configured to:
use said at least one receiver to receive a request to obtain a part of a file from a requestor, said request identifying said file, starting position, said file comprising a plurality of spatial-element frames of a spatial element of a compressed video, said compressed video comprising a plurality of spatial elements,
locate said file in a memory,
obtain data from said file located in said memory, and
use said at least one transmitter to transmit said data to said requestor,
wherein said request specifies a starting position, said data is obtained starting at said specified starting position, and said data comprises two or more temporal segments of spatial-element frames relating to at least partly overlapping time periods, said spatial-element frames of said two or more temporal segments each comprising a plurality of video pixels, at least a first one of said two or more temporal segments of spatial-element frames comprising inter-coded spatial-element frames and at least a second one of said two or more temporal segments of spatial-element frames comprising only non-inter-coded spatial-element frames, only said inter-coded spatial-element frames being encoded with reference to one or more other spatial-element frames of said plurality of spatial-element frames and said two or more temporal segments being located near each other in said data.

16. The method as claimed in claim 1, further comprising determining said starting point by looking up a position in a file by using an index associated with said file, said position corresponding substantially to a current time and said index comprising a mapping from a point in time or a temporal index value to a position in said file.

17. The method as claimed in claim 9, wherein said two or more temporal segments of spatial-element frames are stored sequentially in said file.

18. A computer readable medium for storing instructions when executed on a computer system perform a method comprising:
for each spatial element of a video in a user's field of view for which a client device does not possess a current high-resolution spatial-element frame, said client device transmitting one or more requests for high-resolution spatial-element frames of said spatial element of said video to a distribution node, said video comprising a plurality of spatial elements and a plurality of spatial-element frames for each of said plurality of spatial elements, said plurality of spatial-element frames comprising both non-inter-coded spatial-element frames and inter-coded spatial-element frames, only said inter-coded spatial-element frames being encoded with reference to one or more other spatial-element frames of said plurality of spatial-element frames, said one or more requests identifying said spatial element; and
for each of said spatial elements for which said one or more requests is transmitted, said client device receiving data relating to said spatial element of said video from said distribution node in response to said one or more requests, said data comprising a temporal segment of high-resolution spatial-element frames, said high-resolution spatial-element frames of said temporal segment each comprising a plurality of video pixels,
wherein said one or more requests specify a starting point corresponding to a current time, said one or more requests are for data comprising a temporal segment of high-resolution spatial-element frames starting at said starting point of which the first high-resolution spatial-element frame is not inter coded, and said temporal segment of high-resolution spatial-element frames received by said client device starts at said starting point, the first one or more high-resolution spatial-element frames of said temporal segment of high-resolution spatial-element frames not being inter coded.

19. A computer readable medium for storing instructions when executed on a computer system perform a method comprising:
receiving a request to obtain a part of a file from a requestor, said request identifying said file, said file comprising a plurality of spatial-element frames of a spatial element of a compressed video, said compressed video comprising a plurality of spatial elements;
locating said file in a memory;
obtaining data from said file located in said memory; and
transmitting said data to said requestor,
wherein said request specifies a starting position, said data is obtained starting at said specified starting position, and said data comprises two or more temporal segments of spatial-element frames relating to at least partly overlapping time periods, said spatial-element frames of said two or more temporal segments each comprising a plurality of video pixels, at least a first one of said two or more temporal segments of spatial-element frames comprising inter-coded spatial-element frames and at least a second one of said two or more temporal segments of spatial-element frames comprising only non-inter-coded spatial-element frames, only said inter-coded spatial-element frames being encoded with reference to one or more other spatial-element frames of said plurality of spatial-element frames and said two or more temporal segments being located near each other in said data.
